(19) United States
(12) Patent Application Publication
(10) Pub. No.: US 2009/0128707 A1
(43) Pub. Date: May 21, 2009

(54) Image Display Apparatus and Method

(75) Inventors: Hideharu HATTORI, Kawasaki (JP); Koichi Hamada, Yokohama (JP); Nobuhiro Fukuda, Tokyo (JP); Yutaka Chiaki, Yokohama (JP); Yoshiaki Takada, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd, Chiyoda-ku (JP)

(21) Appl. No.: 12/255,792

(22) Filed: Oct. 22, 2008

(30) Foreign Application Priority Data
Oct. 23, 2007 (JP) 2007-275110

(51) Int. Cl. H04N 5/14

(52) U.S. Cl. 348/699; 348/E05.062

(57) ABSTRACT

It is possible to better correct dynamic false contours in gradation display made by dividing each field into plural subfields. A motion vector detection section detects a motion vector extending between pixels mutually corresponding between two mutually neighboring fields. A pixel position changing section calculates a pixel position vector indicating from where to acquire data for use in rearranging emission data by multiplying a motion vector ending at a pixel to be rearranged by a predetermined function. Furthermore, when a brightness difference between the pixel from which data is to be acquired and the pixel to be rearranged is larger than a threshold value, the pixel position changing section corrects the calculated pixel position vector to change the pixel indicated thereby to one closer to the pixel to be rearranged until the brightness difference is equal to or smaller than the threshold value.

### CLAIM OF PRIORITY

The present application claims priority from Japanese patent application serial No. JP 2007-275110, filed on Oct. 23, 2007, the content of which is hereby incorporated by reference into this application.

### BACKGROUND OF THE INVENTION

(1) Field of the Invention

The present invention relates to an image display apparatus and method in which a field is divided time-wise into plural parts for gradation display.

(2) Description of the Related Art

A display device which, to display one field of image, divides time-wise the field into plural differently weighted parts (hereinafter referred to as “subfields (SFs))” and controls emission on and off for each subfield has a problem in that, when it displays a moving image, gradation disorder or moving image blurring referred to as a dynamic false contour is caused to degrade the quality of image display. Such a phenomenon is known to be caused when human eyes trace an image of a moving object on a display screen.

A gradation display method in which the generation of dynamic false contours can be prevented is disclosed in Japanese Patent Laid-Open No. H08-211848. In the method, a motion vector is detected based on interframe or interfield display data, and the emission position of each display data subfield is corrected to the pixel position of each subfield falling upon a line-of-sight path calculated based on the motion vector.

Japanese Patent Laid-Open No. 2002-123211 discloses a method in which each subfield is re-encoded using subfield drag coordinates calculated based on a motion vector and the emission center position of the subfield.

### SUMMARY OF THE INVENTION

When known methods for false contour correction are used, there are cases in which motion vectors extending in various directions are included in an image frame, motion vectors are detected erroneously, or motion vectors are erroneously detected from data on telop characters. In such known methods, erroneous detection of motion vectors is unavoidable, so that there are cases in which emission positions of subfields are corrected based on erroneously detected motion vectors. This can cause the generation of false colors and shaking of telop characters, resulting in image quality deterioration.

When emission positions of subfields are corrected using the method disclosed in Japanese Patent Laid-Open No. H08-211848, there are cases in which subfields of some pixels are left with no rearranged emission data. Furthermore, in the method, subfields of pixels are rearranged based only on motion vectors without colors of neighboring pixels taken into consideration, so that there are cases in which the brightness of pixels largely change when their subfields are rearranged or in which a difference in brightness not observed on an image appears on the screen resulting in a false color display.

When subfields are re-encoded by the method disclosed in Japanese Patent Laid Open No. 2002-123211, too, subfield drag coordinates are calculated based only on motion vectors without colors of neighboring pixels taken into consideration, so that there are cases in which the brightness of pixels largely changes when their subfields are re-encoded or in which a difference in brightness not observed on an image appears on the screen resulting in a false color display. These phenomena disrupt the correction of dynamic false contours, and degrade image quality.

The above problems will be described below with reference to FIGS. 25 to 29D.

FIG. 25 is a diagram for explaining a method of gradation representation used by a display apparatus designed to represent gradation using subfields. In the method, each field (TV field) is composed of as many as N subfields which are each weighted, for example, by the Nth power of 2.

In the example shown in FIG. 25, the subfields are weighted, in order of increasing brightness, by 2 to the 0th power, 2 to the 1st power, - - - , 2 to the (N−1)th power. The subfields are referred to, from the leading side toward the ending side of each TV field, as SF1, SF2, - - - , SFn. In the present example, n=8. The display apparatus represents gradation of each field by controlling emission on and off for plural subfields. The sum of brightness of plural emitting subfields is felt as brightness by the retinas of human eyes.

With different subfields emitting at different times, when the viewer's eyes trace a moving object in a moving image, and positions of emitting subfields of pixels mutually adjacent in a field largely vary, a dynamic false contour is generated.

FIGS. 26A and 26B show an example mechanism of generation of a dynamic false contour. In each of FIGS. 26A and 26B, the passage of time (field time) is represented in the vertical direction, and pixel positions are represented in the horizontal direction. The number n of subfields is 8. The pixels sequentially arranged along the horizontal direction are progressively higher in brightness in the leftward direction, the brightness increment between adjacent pixels being 1.

Referring to FIG. 26A, the display of the sequential pixels in the first field period is shifted by two pixels to the right in the second field period. The pixels with brightnesses of 127, 128, and 129, respectively, will be recognized, in a still image state, as pixels having the respective brightnesses as they are.

In a moving image state, however, the viewer's line of sight moves tracing the moving image as indicated by arrows. This causes the viewer's eyes to recognize subfield emission periods differently when a moving image is displayed than when a still image is displayed. In the example shown in FIG. 26A, the pixels with brightnesses of 127, 128, and 129, respectively, in a still image state are recognized by the viewer's eyes as pixels with brightnesses of 127, 0, and 129 in a moving image state. Thus, a pixel with a brightness of 0 which is not displayed in a still image state is recognized by the viewer's eyes in a moving image state.

In a case in which, as shown in FIG. 26B, the display of sequential pixels in the first field period is shifted by two pixels to the left in the second field period. The pixels with brightnesses of 127, 128, and 129, respectively, in a still image state will be recognized by the viewer's eyes as pixels with brightnesses of 126, 255, and 128, respectively, in a moving image state. Thus, a pixel with a brightness of 255 which is not displayed in a still image state is recognized by the viewer's eyes in a moving image state. This is a mechanism of generation of a dynamic false contour.

FIG. 27 is a diagram for explaining a known method of subfield correction performed to prevent the generation of dynamic false contours. FIG. 27 shows display data in a field having six subfields (N=6) with the horizontal axis representing positions in the horizontal direction of pixels and the vertical axis representing field time. In the following, the transition of emitting states of the subfields of pixel n representing display data will be explained.

When, during a moving image display, display data moves by six pixels in the horizontal direction, i.e. movement for a vector value of +6, what the retinas of the viewer's eyes recognize are the subfields emitting in an area sandwiched between two diagonal lines (line-of-sight path 2710). As explained above with reference to FIGS. 26A and 26B, the brightness of emitting subfields integrated on the retinas of the viewer's eyes differs from the corresponding brightness that would be shown during a still image display. In the known method, false dynamic contours are corrected by changing emission positions of plural subfields positioned on a same pixel in a still image state to emission positions of subfields on pixels falling on a line-of-sight path.

FIGS. 28A to 28C are diagrams for explaining cases where, in the known method of subfield rearrangement, some subfields are left without being set. FIGS. 28A to 28C show display data in a field having six subfields (N=6) with the horizontal axis representing positions in the horizontal direction of pixels and the vertical axis representing field time. The display data shown in FIG. 28A represents a subfield emission pattern before subfield rearrangement. In FIG. 28A, the subfields belonging to a same pixel are shown identically patterned.

FIG. 28B shows an example result of rearranging emission positions of subfields by the known method by moving pixels (n−5) to (n−1) by five pixels horizontally and pixels n to (n+5) by six pixels horizontally. The subfields shown inside a framed area 2810 are left without being set (left as non-emitting subfields).

FIG. 28C shows another example result of subfield rearrangement carried out by the known method. In this case, pixels (n−5) to (n−1) are included in a still background image area (i.e. moved by zero pixel horizontally), and pixels n to (n+5) included in a moving image area are moved by six pixels horizontally. The subfields shown inside a triangularly framed area 2811 are left without being set.

As described above, when subfields are rearranged by the known method, some subfields are left without being set resulting in image quality deterioration. In such a case, the brightnesses of pixels largely change causing something like lines, which are not included in the real image being displayed, to be shown by pixels largely differing in brightness.

FIGS. 29A to 29D are diagrams for explaining a problem with the known method, i.e. the generation of false colors resulting from subfield rearrangement carried out causing the arrangement of emitting subfields to largely change between pixels mutually largely differing in brightness.

FIG. 29A shows pixels on a two-dimensional plane with gray circles representing low-brightness pixels and white circles representing high-brightness pixels. In this example, it is assumed that: the brightness difference between gray pixels or between white pixels is smaller than or equal to a threshold value; and the brightness difference between any gray pixel and any white pixel is larger than the threshold value. It is also assumed that pixels A to G are moved by six pixels in the direction indicated by the arrow 2910 extending from pixel G to pixel A.

FIG. 29B shows a state of subfield emissions for pixels A to F before rearrangement.

FIG. 29C shows a result of subfield rearrangement carried out (with emission center positions taken into consideration) for pixel A. According to motion vectors and emission center positions, pixel A is rearranged using SF5 and SF6 of pixel C (as indicated by arrows 2905 and 2906), SF3 and SF4 of pixel B (as indicated by arrows 2903 and 2904), and SF1 and SF2 of pixel A. In this example, with correction to be made according to emission center positions taken into consideration, the subfields are rearranged based on the assumption that each subfield starts emission early.

FIG. 29D shows a result of rearrangement of pixels A to F carried out in a similar manner. As shown, the subfield arrangement for pixels A to C largely differs from the corresponding subfield arrangement for the original image. This indicates that the rearrangement of pixels A to C generated false colors. Thus, when the known method of subfield rearrangement is used, the arrangement of emitting subfields largely changes for some pixels resulting in image quality deterioration.

As described above, the existing method has a problem in that the correction of dynamic false contours can be disrupted to cause image quality deterioration.

The present invention has been made in view of the above problem, and it is an object of the invention to better correct dynamic false contours so as to prevent image quality deterioration in gradation display made by dividing each field into plural subfields.

The image display apparatus according to the present invention includes: a subfield conversion section which converts an input image into emission data for plural subfields; a motion vector detection section which detects a motion vector extending between pixels mutually corresponding between two mutually neighboring fields included in plural fields of the input image or generated from the plural fields; a brightness information calculation section which calculates, from the input image, brightness information for each pixel; a pixel position changing section which calculates, by performing arithmetic processing using a motion vector detected by the motion vector detection section and brightness information calculated by the brightness information calculation section, a pixel position vector indicating from where to acquire data for use in rearranging emission data; a subfield rearrangement section which rearranges emission data, outputted from the subfield conversion section, for a subfield of a pixel in a field to be rearranged using emission data for a corresponding subfield of another pixel included in the field to be rearranged and indicated by a pixel position vector calculated by the pixel position changing section; and a display section which displays an image using subfield emission data outputted from the subfield rearrangement section.

The pixel position changing section selects, out of the motion vectors detected by the motion vector detection section, a motion vector ending at a pixel to be rearranged in the field to be rearranged; calculates the pixel position vector by multiplying the selected motion vector by a predetermined function; checks, based on the brightness information calculated by the brightness information calculation section, a brightness difference between the pixel indicated by the calculated pixel position vector and the pixel to be rearranged; and, when the brightness difference is larger than a threshold value, outputs the calculated pixel position vector after correcting it to change the pixel indicated thereby to one closer to the pixel to be rearranged until the brightness difference between the pixel thus changed to and the pixel to be rearranged is equal to or smaller than the threshold value.

The image display method according to the present invention includes the steps of: converting an input image into emission data for plural subfields; detecting a motion vector extending between pixels mutually corresponding between two mutually neighboring fields included in plural fields of the input image or generated from the plural fields; calculating, from the input image, brightness information for each pixel; calculating, by performing arithmetic processing using the detected motion vector and the calculated brightness information, a pixel position vector indicating from where to acquire data for use in rearranging emission data; rearranging emission data for a subfield of a pixel in a field to be rearranged using emission data for a corresponding subfield of another pixel included in the field to be rearranged and indicated by the calculated pixel position vector; and displaying an image using emission data for the subfield to be rearranged.

In the step of calculating a pixel position vector: a motion vector ending at a pixel to be rearranged in the field to be rearranged is selected; a pixel position vector is calculated by multiplying the selected motion vector by a predetermined function; based on the calculated brightness information, a brightness difference between the pixel indicated by the calculated pixel position vector and the pixel to be rearranged is checked; and, when the brightness difference is larger than a threshold value, the calculated pixel position vector is corrected to change the pixel indicated thereby to one closer to the pixel to be rearranged until the brightness difference between the pixel thus changed to and the pixel to be rearranged is equal to or smaller than the threshold value.

According to the present invention, in gradation display made by dividing each field into plural subfields, a quality image free of image quality deterioration can be produced.

### BRIEF DESCRIPTION OF THE DRAWINGS

These and other features, objects and advantages of the present invention will become more apparent from the following description when taken in conjunction with the accompanying drawings wherein:

FIG. 1 is a block diagram of an example image display apparatus according to a first embodiment of the present invention;

FIG. 2 is a flowchart of the image display method according to the first embodiment;

FIG. 3 is a flowchart for determining a pixel position vector for each subfield;

FIGS. 4A to 4C are diagrams showing an example of subfield rearrangement according to the first embodiment;

FIGS. 5A to 5C are diagrams showing an example of subfield rearrangement according to the first embodiment;

FIGS. 6A to 6C are diagrams showing example display patterns for explaining effects of the first embodiment;

FIGS. 7A to 7C are diagrams showing example display patterns for explaining effects of the first embodiment;

FIGS. 8A to 8D are diagrams showing an example display pattern for explaining effects of the first embodiment;

FIGS. 9A and 9B are timing diagrams showing emission times of subfields;

FIG. 10 is a block diagram of an example image display apparatus according to a second embodiment of the present invention;

FIG. 11 is a flowchart of the image display method according to the second embodiment;

FIGS. 12A to 12C are diagrams showing an example of subfield rearrangement according to the second embodiment;

FIGS. 13A to 13C are diagrams showing an example of subfield rearrangement according to the second embodiment;

FIG. 14 is a diagram for explaining an intermediate field and a motion vector F;

FIG. 15 is a block diagram of an example image display apparatus according to a third embodiment of the present invention;

FIG. 16 is a flowchart of the image display method according to the third embodiment;

FIGS. 17A to 17C are diagrams showing an example of subfield rearrangement according to the third embodiment;

FIGS. 18A to 18C are diagrams showing an example of subfield rearrangement according to the third embodiment;

FIG. 19 is a block diagram of an example image display apparatus according to a fourth embodiment of the present invention;

FIG. 20 is a flowchart of the image display method according to the fourth embodiment;

FIGS. 21A to 21C are diagrams showing an example of subfield rearrangement according to the fourth embodiment;

FIGS. 22A to 22C are diagrams showing an example of subfield rearrangement according to the fourth embodiment;

FIG. 23 is a diagram of an example image for a fifth embodiment of the present invention;

FIGS. 24A to 24D are diagrams showing an example display pattern according to the sixth embodiment of the present invention;

FIG. 25 is a diagram for explaining a method of gradation representation using subfields;

FIGS. 26A and 26B are diagrams showing an example mechanism of generation of a dynamic false contour;

FIG. 27 is a diagram for explaining a known method of subfield correction;

FIGS. 28A to 28C are diagrams for explaining a problem with a known method of subfield correction; and

FIGS. 29A to 29D are diagrams for explaining a problem with a known method of subfield correction.

### DETAILED DESCRIPTION OF THE PREFERRED EMBODIMENTS

Preferred embodiments of the present invention will be described below with reference to the accompanying drawings.

FIGS. 9A and 9B are timing diagrams showing when each subfield emits light. FIG. 9A shows a case in which the subfields within each field emit light sequentially at regular intervals. FIG. 9B shows a case in which the subfields emit light at variable intervals (irregular intervals). The following embodiments will be described based on these two cases.

Referring to the attached drawings, elements denoted by same reference numerals have same functions. In the following description, the expression “subfield” includes the meaning of “subfield period,” and the expression “subfield emission” includes the meaning of “pixel emission during a subfield period.” Furthermore, in the following description and the attached drawings, when a scalar quantity referred to merely as a motion vector value, it represents a magnitude of horizontal movement out of a two-dimensional vector. For example, when a scalar quantity “6” is referred to, it represents a motion vector (x, y)=(+6, 0), where “x” and “y” represent the horizontal and vertical directions, respectively, on a display screen.

### Embodiment 1

A first embodiment of the present invention concerns an image display for which the subfields of each field sequentially start emission at regular intervals as shown in FIG. 9A. In FIG. 9A, display data represented by six subfields (number of subfields N=6) is shown with the horizontal axis representing horizontal pixel positions and the vertical axis representing field time. Regardless of the subfield emission periods E1 to E5, the intervals between subfield emission starting times are constant at T0.

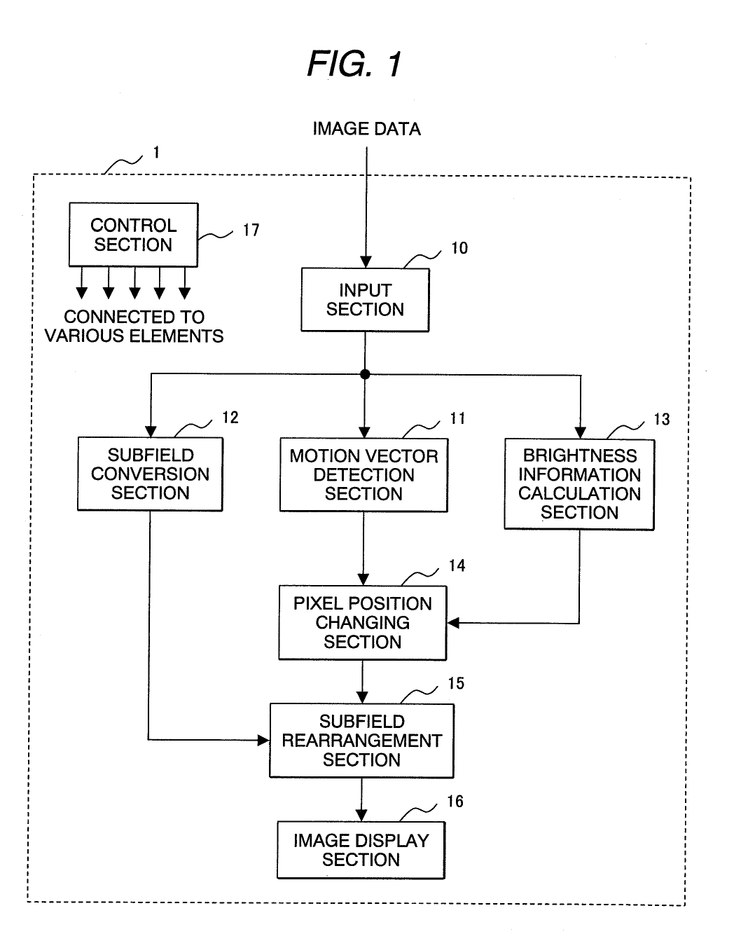

FIG. 1 is a block diagram of an example image display apparatus according to the first embodiment of the present invention. An image display apparatus 1 includes an input section 10, a motion vector detection section 11, a subfield conversion section 12, a brightness information calculation section 13, a pixel position changing section 14, a subfield rearrangement section 15, an image display section 16, and a control section 17.

The operation of each of the above sections will be described below in detail. Moving image data is inputted to the input section 10. The input section 10 has, for example, a tuner for TV broadcast signals, an image input terminal, and a network connection terminal. In the input section 10, input moving image data undergoes, for example, conventional conversion processing, and the display data obtained as a result of such conversion processing is outputted to the motion vector detection section 11.

In the motion vector detection section 11, by comparing the display data in an object field and the display data in the field preceding the object field, a motion vector extending from a pixel in the preceding field to an object pixel in the object field is detected. In the subfield conversion section 12, the display data is converted into subfield data. In the brightness information calculation section 13, brightness information is calculated based on the image data inputted to the input section 10.

In the pixel position changing section 14, a pixel position vector indicating the pixel a subfield of which is to be used to rearrange an object subfield of an object pixel is calculated. This is done by using, out of the motion vectors detected in the motion vector detection section 11, the one ending at the pixel of the object field, the brightness information calculated in the brightness information calculation section 13, and such subfield information as the number of subfields and subfield number. In the subfield rearrangement section 15, out of the subfield data outputted from the subfield conversion section 12, the subfield emission data for the pixel indicated by the pixel position vector calculated in the pixel position changing section 14 is obtained. The emission data thus obtained is set on the subfield to be rearranged of the pixel to be rearranged. By repeating this process, the subfields of each pixel to be rearranged are rearranged using the subfield data outputted from the subfield conversion section 12.

The image display section 16 has plural pixels which can emit light and displays an image by controlling the light emission of each of the plural pixels on and off based on the subfield data obtained in the subfield rearrangement section 15. The control section 17 is connected to various elements of the display apparatus. The elements of the display apparatus operate according to the autonomous operations of the above-described sections or according to instructions from the control section 17.

As described above, in the display apparatus according to the present embodiment, the pixel position changing section 14 rearranges the subfields of each pixel to be rearranged based on, out of the motion vectors detected in the motion vector detection section 11, the one ending at each pixel to be rearranged of the object field and the brightness information calculated in the brightness information calculation section 13.

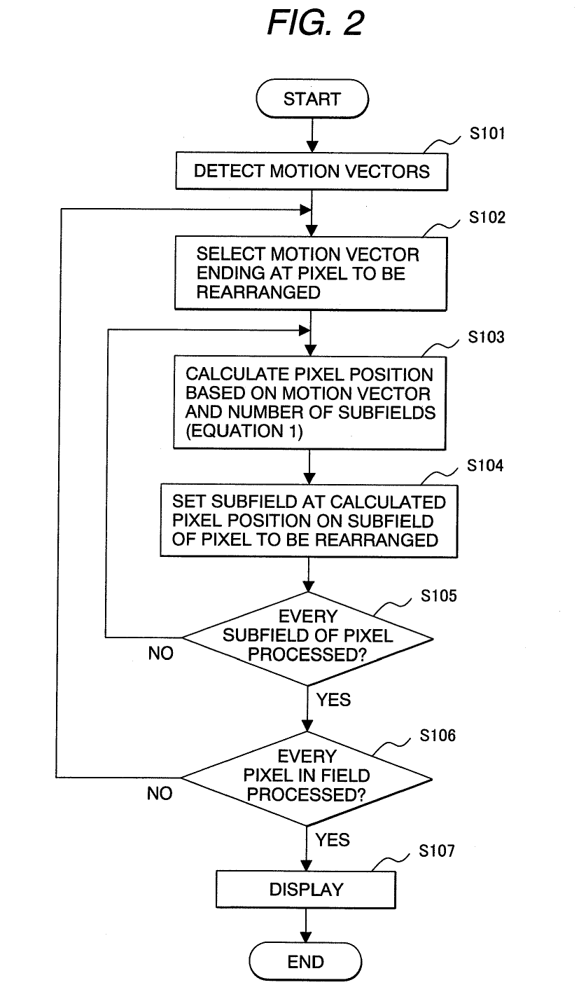

FIG. 2 is a flowchart of the image display method according to the first embodiment.

In step 101, the motion vector detection section 11 compares the display data in an object field and the display data in a field preceding the object field. Based on the comparison results, the motion vector detection section 11 detects a motion vector extending from a pixel in the preceding field to a pixel in the object field. This is done for every pixel in the object field.

In step 102, out of the motion vectors detected in step 101, the one ending at an object pixel is selected.

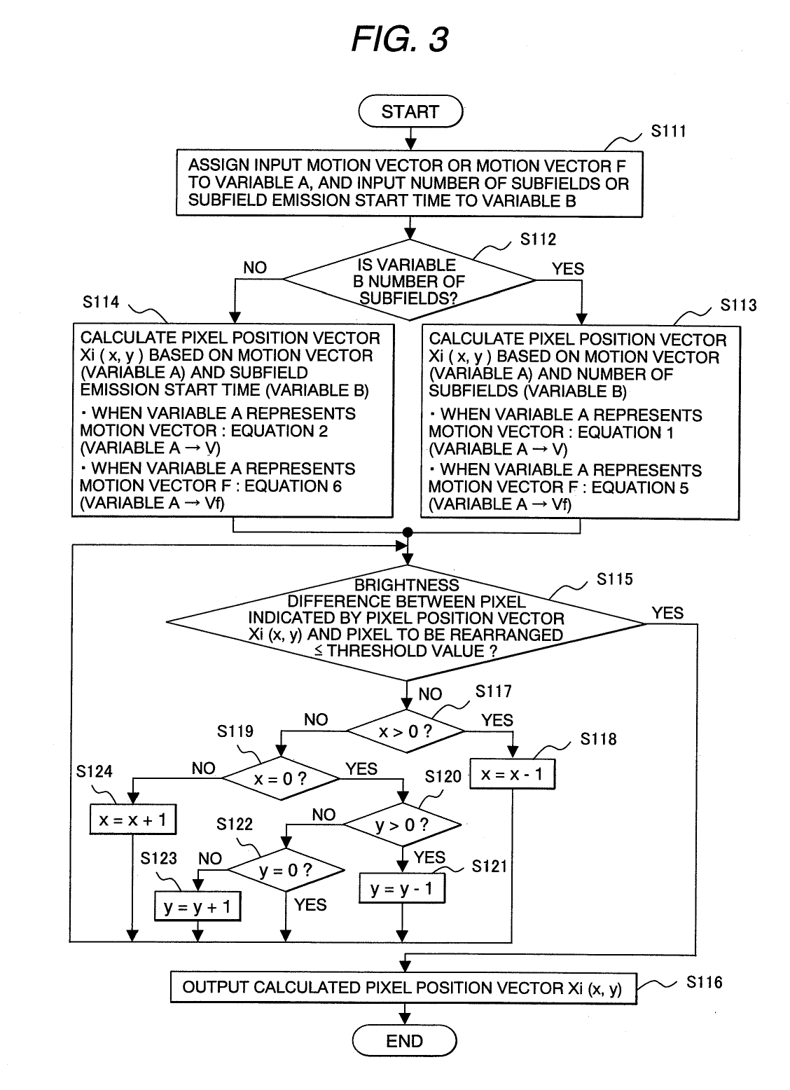

In step 103, the pixel position changing section 14 determines, for a subfield to be rearranged of the object pixel, a pixel position vector indicating the subfield to be acquired for subfield rearrangement. This is done by inputting the motion vector selected in step 102 and such subfield information as the subfield number of the object subfield and the number of subfields per field and using the procedure shown in FIG. 3 and a computing equation (for example, equation 1) being explained later. When doing this, the pixel position changing section 14 corrects the pixel position vector based on the brightness information on the pixel indicated by the pixel position vector determined as described above and the pixel to be rearranged.

In step 104, the subfield rearrangement section 15 sets the emission data obtained from the subfield indicated by the pixel position vector on the object subfield of the pixel to be rearranged of the object field.

In step 105, whether every subfield of the pixel to be rearranged has been rearranged is determined. When every subfield is determined to have been rearranged, the procedure advances to step 106; otherwise, the procedure returns to step 103 to repeat steps 103 and 104 for the remaining subfields yet to be rearranged.

In step 106, whether every subfield of every pixel in the object field has been rearranged is determined. When every subfield of every pixel is determined to have been rearranged, the procedure advances to step 107; otherwise the procedure returns to step 102 to repeat steps 102 to 105 for the remaining pixels.

In step 107, the image display section 16 displays the display data in the object field obtained in step 106. Determining whether processing has been completed for every subfield or every pixel as done in steps 105 and 106 may be performed by the control section 17.

FIG. 3 is a detailed flowchart of the process performed in step 103 shown in FIG. 2. In the process, the pixel position changing section 14 determines the pixel position vector of each subfield. Note that the flowchart shown in FIG. 3 has been generalized so that it can be applied to other embodiments, too.

In step 111, a motion vector or motion vector F is assigned to variable A, and the number of subfields or subfield emission start time is assigned to variable B.

In step 112, whether variable B is equal to the number of subfields is determined. When variable B is determined to be equal to the number of subfields, the procedure advances to step 113 where a pixel position vector Xi (x, y) for acquiring a required subfield is determined based on the motion vector represented by variable A and the number of subfields represented by variable B. At this time, either equation 1 or equation 5 being described later is used. When, in step 112, variable B is determined to be the subfield emission start time, the procedure advances to step 114 where a pixel position vector Xi (x, y) for acquiring a required subfield is determined based on the motion vector represented by variable A and the subfield emission start time represented by variable B. At this time, either equation 2 or equation 6 being described later is used.

In step 115, whether the brightness difference between the pixel indicated by the pixel position vector Xi (x, y) thus determined and the pixel to be rearranged is either smaller than or equal to a threshold value is determined. The threshold value based on which the brightness difference is checked is preferably, for example, about 30 for a 256-gradation display.

When the brightness difference is determined to be either smaller than or equal to the threshold value, the procedure advances to step 116 where the pixel position vector Xi (x, y) is outputted. When not, the procedure advances to step 117 to correct the pixel position vector Xi (x, y).

The pixel position vector Xi (x, y) is corrected as follows. In step 117, whether x is larger than 0 (x>0) is determined. When x is larger than 0, x is decremented by 1 in step 118. The procedure then returns to step 115. When, in step 117, x is determined to be either smaller than or equal to 0 (x≦0), whether x is 0 is determined in step 119. When x is 0, whether y is larger than 0 (y>0) is determined in step 120. When y is larger than 0, y is decremented by 1 in step 121. The procedure then returns to step 115. When, in step 120, y is determined to be either smaller than or equal to 0 (y≦0), whether y is 0 is determined in step 122. When y is 0, the procedure returns to step 115. When, in step 122, y is determined not to be 0, y is incremented by 1. The procedure then returns to step 115. When, in step 119, x is determined not to be 0, x is incremented by 1 in step 124. The procedure then returns to step 115. In this way, steps 117 to 124 are repeatedly performed until it is determined in step 115 that the brightness difference is smaller than or equal to the threshold value. When the brightness difference is eventually determined to be smaller than or equal to the threshold value in step 115, the corrected pixel position vector Xi (x, y) is outputted in step 116. Thus, in the pixel position vector correction process, the pixel position vector Xi (x, y) is brought gradually closer to the pixel to be rearranged until a pixel which makes the brightness difference either smaller than or equal to the threshold value is found.

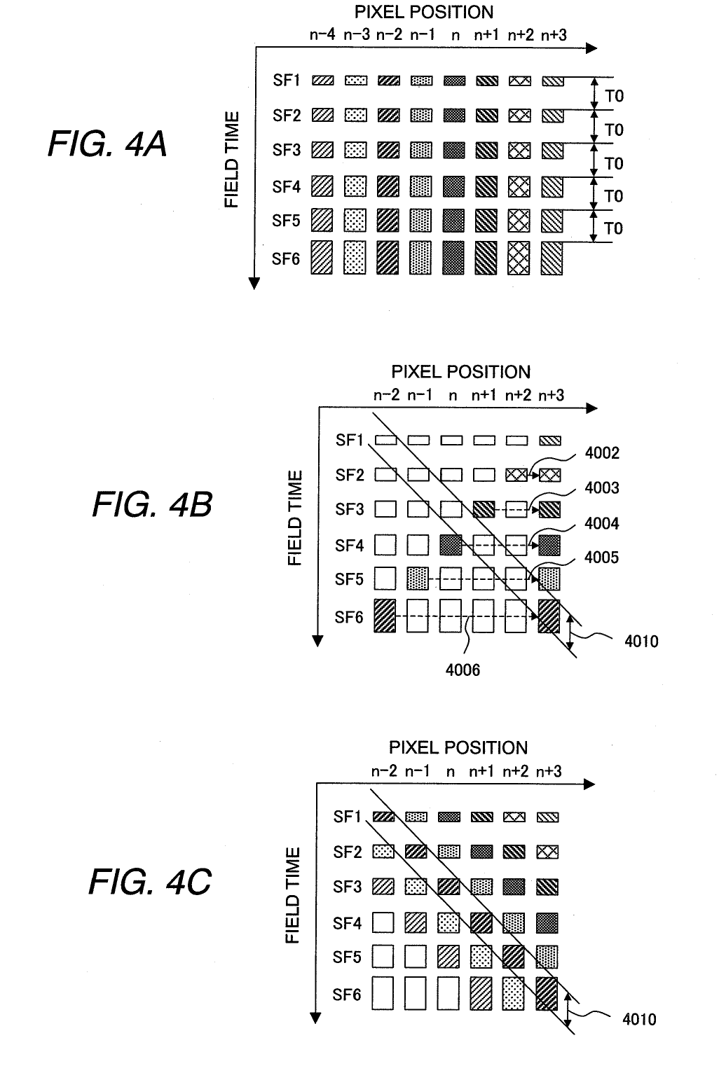

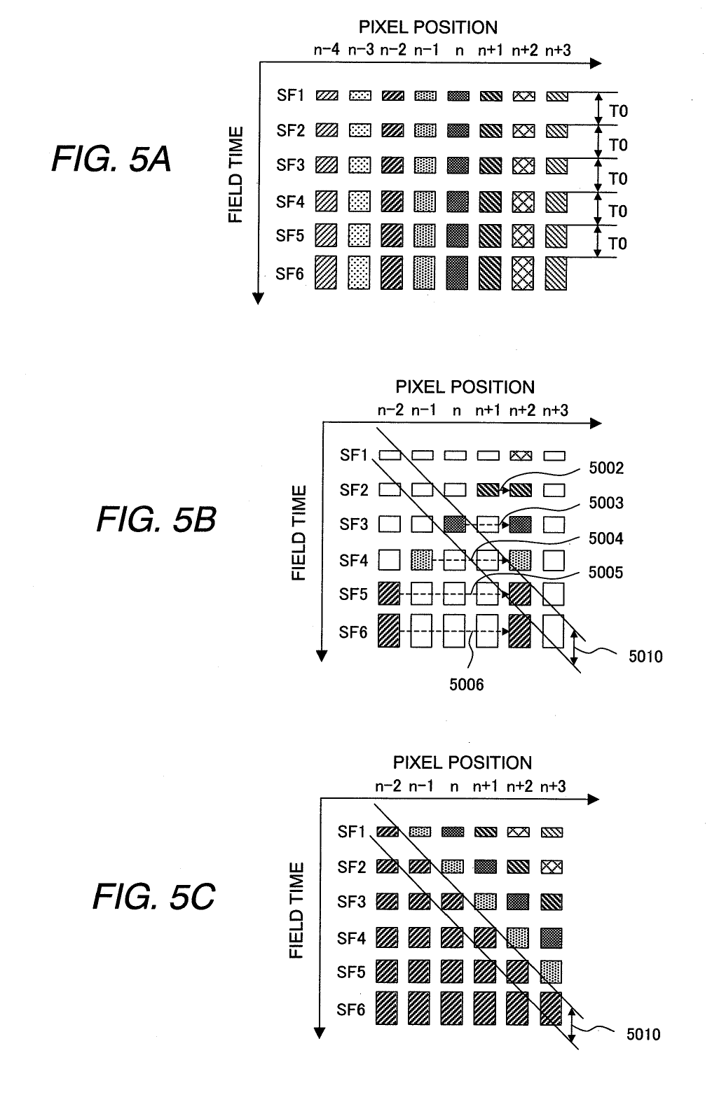

FIGS. 4A to 4C and 5A to 5C are diagrams showing examples of subfield rearrangement according to the present embodiment. In these diagrams, the horizontal axis represents horizontal pixel position, and the vertical axis represents time. The display data shown in these diagrams is represented by six subfields (number of subfields N=6). The result of subfield rearrangement differs between a case where the brightness difference between pixels is smaller than or equal to a threshold value and a case where the brightness difference between pixels is larger than the threshold value. Subfield rearrangements in both cases will be described below.

With reference to FIGS. 4A to 4C, subfield rearrangement made in a case where the brightness difference between pixels is smaller than or equal to a threshold value, i.e. subfield rearrangement for a similar-color area, will be described below. FIG. 4A shows a subfield arrangement before being rearranged. In this case, it is assumed that the brightness difference between pixels ranging from (n−4) to (n+3) is smaller than or equal to a threshold value.

In the present embodiment, the process for pixel position vector calculation shown in FIG. 3 is carried out as follows. In step 111, a motion vector is assigned to variable A, and the number of subfields is assigned to variable B. In step 112, whether variable B is equal to the number of subfields is determined. In the present case, variable B represents the number of subfields, so that, in step 113, a pixel position vector Xi (x, y) for acquiring a required subfield is determined based on the motion vector represented by variable A and the number of subfields represented by variable B. In step 115, whether the brightness difference between the pixel indicated by the pixel position vector Xi (x, y) thus determined and the pixel to be rearranged is either smaller than or equal to a threshold value is determined. In the present case, the brightness difference between pixels ranging from (n−4) to (n+3) is smaller than or equal to the threshold value, so that the procedure advances to step 116 where the determined pixel position vector X1 (x, y) is outputted.

The process performed in step 113 shown in FIG. 3 will be described in detail below.

With reference to FIGS. 4A to 4C, assume that a motion vector ending at a pixel, e.g. (n+3), to be rearranged extends from a pixel positioned at horizontally −6 relative to pixel (n+3). Hence, in this case, the motion vector value is +6.

In cases where the emission start time intervals between subfields are uniform (hereinafter referred to as “regular intervals”), the pixel position of each subfield to be acquired for subfield rearrangement is determined based on the pixel to be rearranged and using equation 1 shown below.

Xi=−V×(i−1)/N (Equation 1)

where: Xi represents the pixel position vector, based on a pixel to be rearranged, of a subfield to be acquired for subfield rearrangement; i represents the subfield number of the subfield to be rearranged; V represents a motion vector value; and N represents the number of subfields per TV field. In the present embodiment, the motion vector value V is of a motion vector which, being among the motion vectors extending between a field to be rearranged and a field preceding the field to be rearranged, extends from a pixel of the preceding field to the pixel to be rearranged of the field to be rearranged. In the example shown in FIGS. 4A to 4C, the vector value V is +6 as mentioned above, so that the motion vector of +6 is used in rearranging each subfield of the pixel to be rearranged.

When a calculated pixel position vector has a decimal fraction, it may be made an integer vector, for example, by rounding it off, up, or down, or it may be used as it is. In the present example being described below, a rounded-down integer motion vector value is used.

In the present embodiment, out of the motion vectors extending between a field to be rearranged and a field preceding the field to be rearranged, one extending from a pixel of the preceding field to a pixel to be rearranged of the field to be rearranged is selected, a pixel position vector is calculated for each subfield to be rearranged using equation 1, and the subfield is rearranged. The process will be described below.

With reference to FIG. 4B, subfield rearrangement for pixel (n+3) will be described below. The motion vector ending at pixel (n+3) to be rearranged extends from a pixel positioned at horizontally −6 relative to pixel (n+3), i.e. the motion vector value is +6. The pixel position vector Xi of each subfield of pixel (n+3) can be calculated using equation 1. The pixel position vector Xi is −5 for SF6, −4 for SF5, −3 for SF4, −2 for SF3, −1 for SF2, and 0 for SF1.

In this case, therefore, SF6 obtains subfield emission data from pixel (n−2) as shown by arrow 4006 in FIG. 4B; SF5 obtains subfield emission data from pixel (n−1) as shown by arrow 4005; SF4 obtains subfield emission data from pixel n as shown by arrow 4004; SF3 obtains subfield emission data from pixel (n+1) as shown by arrow 4003; SF2 obtains subfield emission data from pixel (n+2) as shown by arrow 4002; and SF1 remains unchanged with its emission data on pixel (n+3). In this way, the subfield emission data is rearranged for the subfields of pixel (n+3).

FIG. 4C shows the result of emission data rearrangement carried out for every one of the pixels to be rearranged ranging from (n−2) to (n+3). This example assumes that the motion vectors each ending at a pixel of the field to be rearranged have a same value, +6. The same as done for pixel (n+3) as described above, a pixel position vector Xi is calculated for each subfield of each pixel to be rearranged using equation 1. Subsequently, each subfield of each of the pixels (n−2) to (n+3) is rearranged using the subfield at the pixel position indicated by the corresponding pixel position vector Xi. When the rearrangement is finished, each set of plural subfields associated with a same pixel for a still picture (i.e. each set of subfields identically patterned in FIGS. 4A to 4C) are aligned along a line-of-sight path 4010.

With reference to FIGS. 5A to 5C, subfield rearrangement made in a case where the brightness difference between pixels is, depending on the pixels compared, larger than a threshold value, i.e. subfield rearrangement for a non-similar-color area (e.g. a near-edge area), will be described below.

FIG. 5A shows a subfield arrangement before being rearranged. In this case, it is assumed that, whereas the brightness difference between pixels (n−4) and (n−3) and between pixels ranging from (n−2) to (n+3) is smaller than or equal to a threshold value, the brightness difference between pixels (n−3) and (n−2) is larger than the threshold value.

FIG. 5B shows the result of subfield rearrangement made for pixel (n+2). The motion vector ending at pixel (n+2) to be rearranged extends from a pixel positioned at horizontally −6 relative to pixel (n+2), i.e. the motion vector value is +6. The pixel position vector Xi of each subfield of pixel (n+2) is calculated, using equation 1, as in step 113 shown in FIG. 3. The values of pixel position vectors Xi thus calculated are −5 for SF6, −4 for SF5, −3 for SF4, −2 for SF3, −1 for SF2, and 0 for SF1.

Subsequently, the brightness differences between pixels are checked. For subfield SF6, for example, a pixel position vector Xi (−5, 0) is obtained in step 113. Next, in step 115, the brightness difference between pixels (n−3) and (n+2) is checked. Since the brightness difference between pixels (n−3) and (n+2) is larger than the threshold value, the procedure advances to step 117. Since the value of x determined in step 113 is −5, the procedure advances from step 117 to step 119, then to step 124. In step 124, the value of x is incremented by 1 to −4, then the procedure returns to step 115 to check the brightness difference between pixels (n−2) and (n+2). Since the brightness difference between pixels (n−2) and (n+2) is smaller than or equal to the threshold value, the procedure advances to step 116. In step 116, the pixel position vector Xi of SF6 corrected from (−5, 0) to (−4, 0) is outputted. Pixel position vectors Xi for the other subfields are also calculated in a similar manner. The values of pixel position vectors Xi thus calculated are −4 for SF5, −3 for SF4, −2 for SF3, −1 for SF2, and 0 for SF1.

In the present case, therefore, SF6 obtains subfield emission data from pixel (n−2) as shown by arrow 5006 in FIG. 5B; SF5 obtains subfield emission data from pixel (n−2) as shown by arrow 5005; SF4 obtains subfield emission data from pixel (n−1) as shown by arrow 5004; SF3 obtains subfield emission data from pixel n as shown by arrow 5003; SF2 obtains subfield emission data from pixel (n+1) as shown by arrow 5002; and SF1 remains unchanged with its emission data on pixel (n+2). In this way, the subfield emission data is rearranged for the subfields of pixel (n+2).

FIG. 5C shows the result of emission data rearrangement carried out for every one of the pixels to be rearranged ranging from (n−2) to (n+3). This example assumes that the motion vectors each ending at a pixel of the field to be rearranged have a same value, +6. The same as done for pixel (n+2) as described above, a pixel position vector Xi is calculated for each subfield of each pixel to be rearranged using the procedure shown in FIG. 3 and equation 1. Subsequently, each subfield of each of pixels (n−2) to (n+3) is rearranged using the subfield at the pixel position indicated by the corresponding pixel position vector Xi. Consequently, when pixels (n−2) to (n+3) have been rearranged, their subfields are arranged along a line-of-sight path 5010. The subfields acquired for use in rearranging the pixels are of similar colors to those of the subfields of the pixels to be rearranged. In other words, the pixels are rearranged without using subfields of largely differing colors. The rearranged subfields, therefore, do not show false colors even outside a similar-color area. This makes it possible to inhibit the generation of false contours.

In the first embodiment, the emission start time intervals between subfields are uniform. Since equation 1 includes no parameters to represent subfield emission start time or subfield emission position (middle of emission period), subfields can be rearranged through a relatively small amount of arithmetic processing.

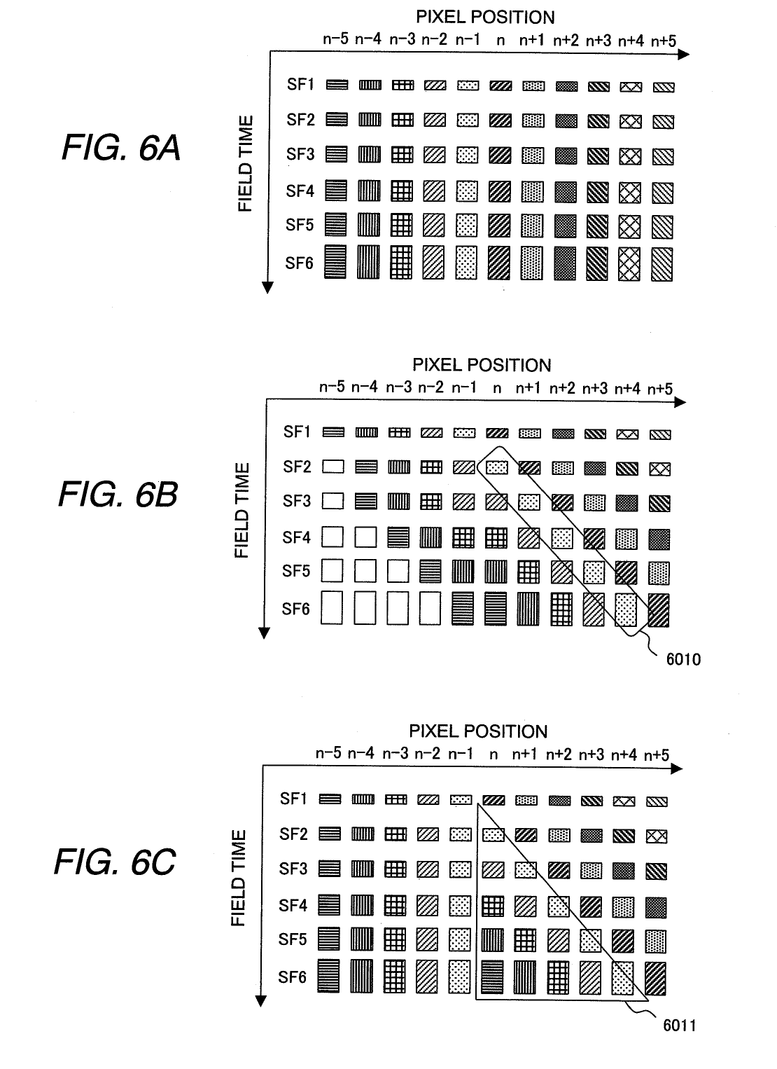

How existing problems with image display are addressed in the present embodiment will be explained below with reference to FIGS. 6A to 6C, 7A to 7C, and 8A to 8C.

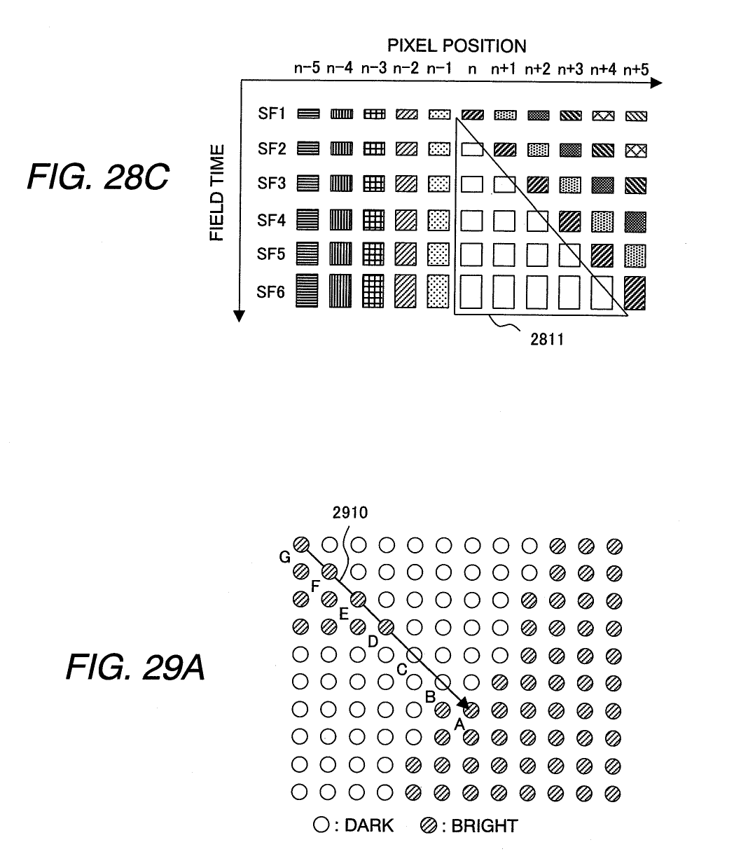

An existing problem with image display is that subfields without any emission data set occur as shown inside framed areas 2810 and 2811 in FIGS. 28B and 28C. In the image display method of the present embodiment, motion vectors ending at pixels to be rearranged are determined, and the subfields of the pixels are rearranged based on the determined motion vectors. In this way, the generation of pixels with subfields with no emission data set can be prevented.

FIGS. 6A to 6C show example display patterns according to the present embodiment. These examples assume that the brightness difference between pixels is smaller than or equal to a threshold value (similar-color area). FIG. 6A shows an example display pattern before rearrangement. FIG. 6B shows an example display pattern obtained by rearranging the display pattern shown in FIG. 6A based on non-uniform motion vectors of pixels. FIG. 6C shows another example display pattern obtained by rearranging the display pattern shown in FIG. 6A based on motion vectors of pixels including those with a vector value of 0 (for a still picture).

Referring to FIG. 6B, assume that every motion vector ending at one of pixels (n−5) to (n−1) among the pixels of a field to be rearranged extends from a pixel positioned at horizontally −5 relative to the pixel at which the motion vector ends. In this case, every one of such motion vectors has a value of +5. Also assume that every motion vector ending at one of pixels n to (n+5) extends from a pixel positioned at horizontally −6 relative to the pixel at which the motion vector ends. In this case, every one of such motion vectors has a value of +6. The pixel position vector Xi of each subfield of each pixel to be rearranged can be calculated based on the corresponding motion vector and using the procedure shown in FIG. 3 and equation 1. The calculation determines the pixel position vector Xi as follows.

When the pixels to be rearranged range from pixel (n−5) to pixel (n−1), the pixel position vector Xi is −4 for SF6, −3 for SF5, −2 for SF4, −1 for SF3, −1 for SF2, and 0 for SF1. When the pixels to be rearranged range from pixel n to pixel (n+5), the pixel position vector Xi is −5 for SF6, −4 for SF5, −3 for SF4, −2 for SF3, −1 for SF2, and 0 for SF1.

FIG. 6B shows the result of pixel rearrangement carried out using the pixel position vectors Xi. Every subfield shown in a framed area 6010 in FIG. 6B also represents rearranged emission data. Thus, it is possible, as shown in FIG. 6B, to rearrange all subfields of all pixels while, for a similar-color area, rearranging subfield emission by taking a line-of-sight path into consideration.

Referring to FIG. 6C, assume that every motion vector ending at one of pixels (n−5) to (n−1) among the pixels of a field to be rearranged extends from a pixel positioned at horizontally 0 relative to the pixel at which the motion vector ends (still picture state). In this case, every one of such motion vectors has a value of 0. Also assume that every motion vector ending at one of pixels n to (n+5) extends from a pixel positioned at horizontally −6 relative to the pixel at which the motion vector ends. In this case, every one of such motion vectors has a value of +6. The pixel position vector Xi of each subfield of each pixel to be rearranged can be calculated based on the corresponding motion vector and using the procedure shown in FIG. 3 and equation 1. The calculation determines the pixel position vector Xi as follows.

When the pixels to be rearranged range from pixel (n−5) to pixel (n−1), the pixel position vector Xi is 0 for every one of SF6, SF5, SF4, SF3, SF2, and SF1. When the pixels to be rearranged range from pixel n to pixel (n+5), the pixel position vector Xi is −5 for SF6, −4 for SF5, −3 for SF4, −2 for SF3, −1 for SF2, and 0 for SF1.

FIG. 6C shows the result of pixel rearrangement carried out using the pixel position vectors Xi. Every subfield shown in a triangular framed area 6011 in FIG. 6C also represents rearranged emission data. Thus, it is possible, as shown in FIG. 6C, to rearrange all subfields of all pixels while, for a similar-color area, rearranging subfield emission by taking a line-of-sight path into consideration.

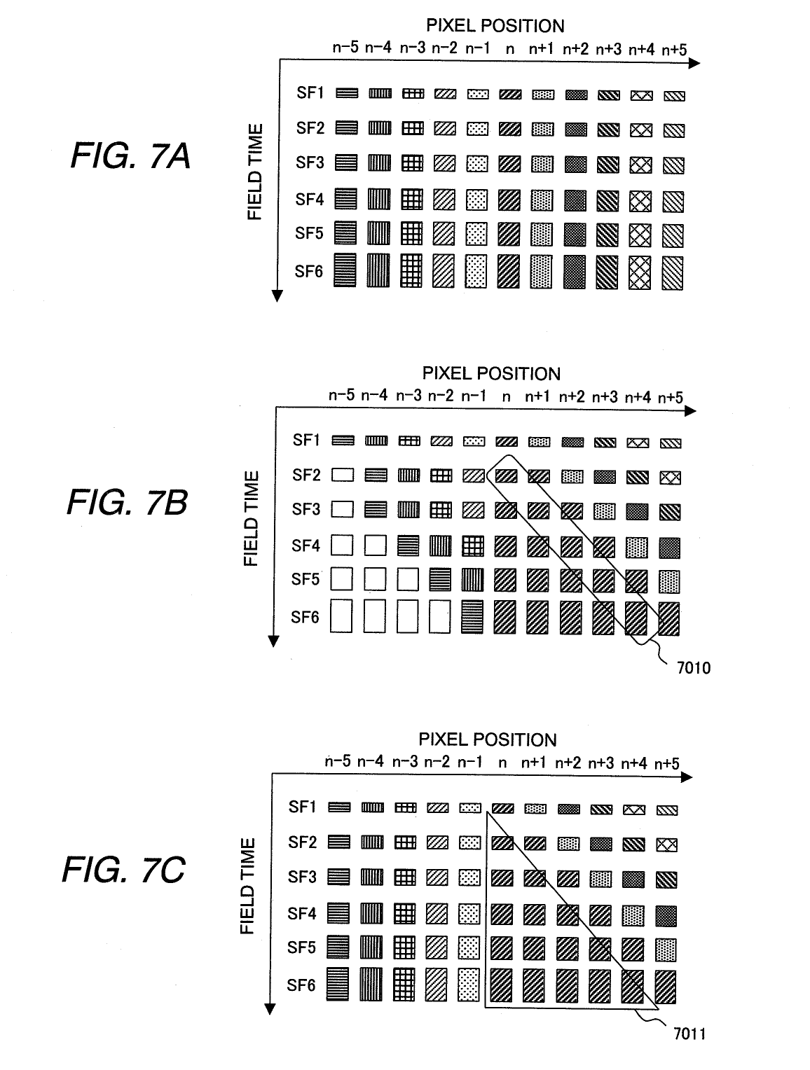

FIGS. 7A to 7C show example display patterns according to the present embodiment. These examples assume that the brightness difference between pixels is, depending on the pixels compared, larger than a threshold value (non-similar-color area). FIG. 7A shows an example display pattern before rearrangement. FIG. 7B shows an example display pattern obtained by rearranging the display pattern shown in FIG. 7A based on non-uniform motion vectors of pixels. FIG. 7C shows another example display pattern obtained by rearranging the display pattern shown in FIG. 6A based on motion vectors of pixels including those with a vector value of 0 (for a still picture). The motion vector of each pixel shown in FIGS. 7B and 7C is assumed to be the same as the motion vector of each pixel shown in FIGS. 6B and 6C.

Referring to FIG. 7A, assume that, among the pixels from n to (n+5) and also among the pixels from (n−5) to (n−1), the brightness difference between pixels is smaller than or equal to a threshold value and that the brightness difference between pixels (n−1) and n is larger than the threshold value.

Referring to FIG. 7B, the pixel position vector Xi of each subfield of each pixel to be rearranged can be calculated using a motion vector similar to those used to obtain the display pattern shown in FIG. 6B and also using the procedure shown in FIG. 3 and equation 1. In this case as in the case shown in FIG. 5B, when the brightness difference between the pixel at which a required subfield is to be acquired and the pixel to be rearranged is not smaller than or equal to a threshold value, the pixel position vector Xi is changed until the brightness difference is smaller than or equal to the threshold value.

FIG. 7B shows the result of pixel rearrangement carried out using the pixel position vectors Xi. Every subfield shown in a framed area 7010 in FIG. 7B also represents rearranged emission data. As shown in FIG. 7B, to rearrange subfields in a non-similar-color area, only subfields of similar colors to the subfields to be rearranged are acquired, and subfields of largely differing colors are not acquired. In this way, the rearranged subfields do not show false colors, and the generation of false contours can be inhibited.

Referring to FIG. 7C, the pixel position vector Xi of each subfield of each pixel to be rearranged can be calculated using a motion vector similar to those used to obtain the display pattern shown in FIG. 6C and also using the procedure shown in FIG. 3 and equation 1. In this case, too, as done to obtain the display pattern shown in FIG. 5B, when the brightness difference between the pixel at which a required subfield is to be acquired and the pixel to be rearranged is not smaller than or equal to a threshold value, the position vector Xi is changed until the brightness difference is smaller than or equal to the threshold value.

FIG. 7C shows the result of pixel rearrangement carried out using the pixel position vectors Xi. Every subfield shown in a triangular framed area 7011 in FIG. 7C also represents rearranged emission data. As shown in FIG. 7C, to rearrange subfields in a non-similar-color area, only subfields of similar colors to the subfields to be rearranged are acquired, and subfields of largely differing colors are not acquired. In this way, the rearranged subfields do not show false colors, and the generation of false contours can be inhibited.

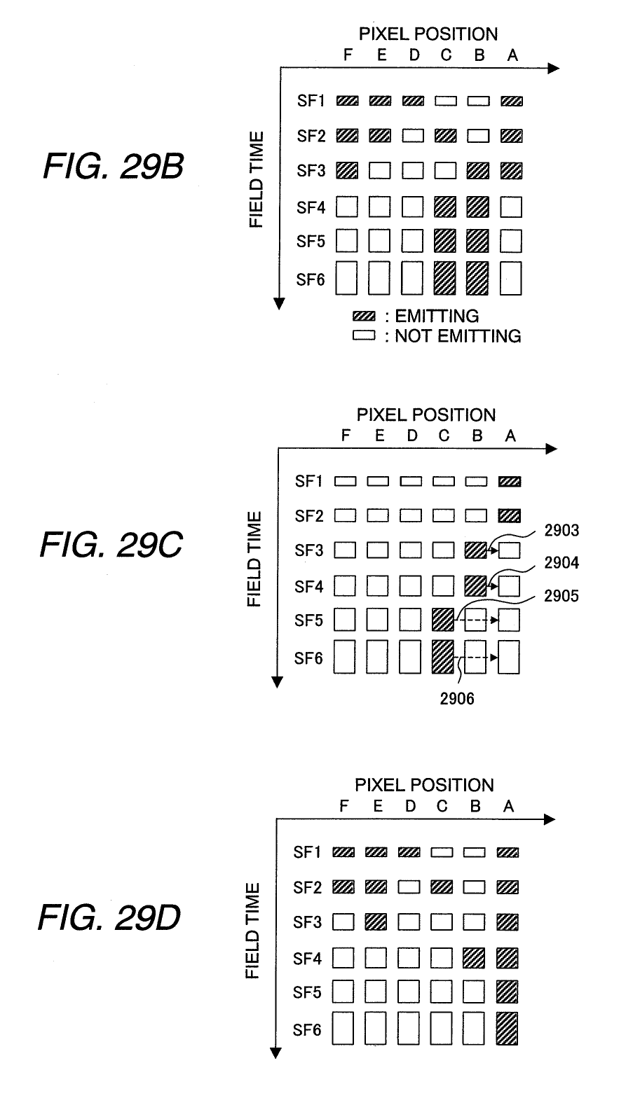

Another existing problem with image display is false color generation caused, for example, when, as shown in FIG. 29D, subfield emission arrangement for pixels A to C largely differs from the original-image subfield arrangement for the pixels. In the display method according to the present embodiment, the brightness differences between pixels are checked, and each pixel to be rearranged is rearranged using subfields of only such a pixel that the brightness difference between it and the pixel to be rearranged is smaller than or equal to a threshold value. This prevents false color generation and makes it possible to inhibit the generation of false contours.

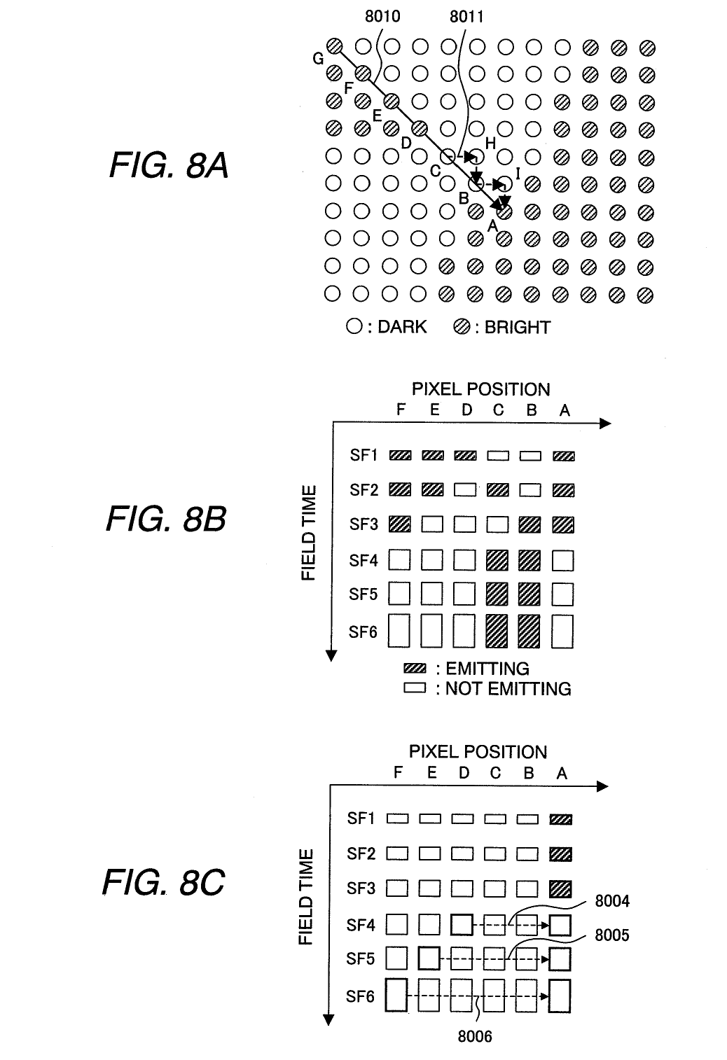

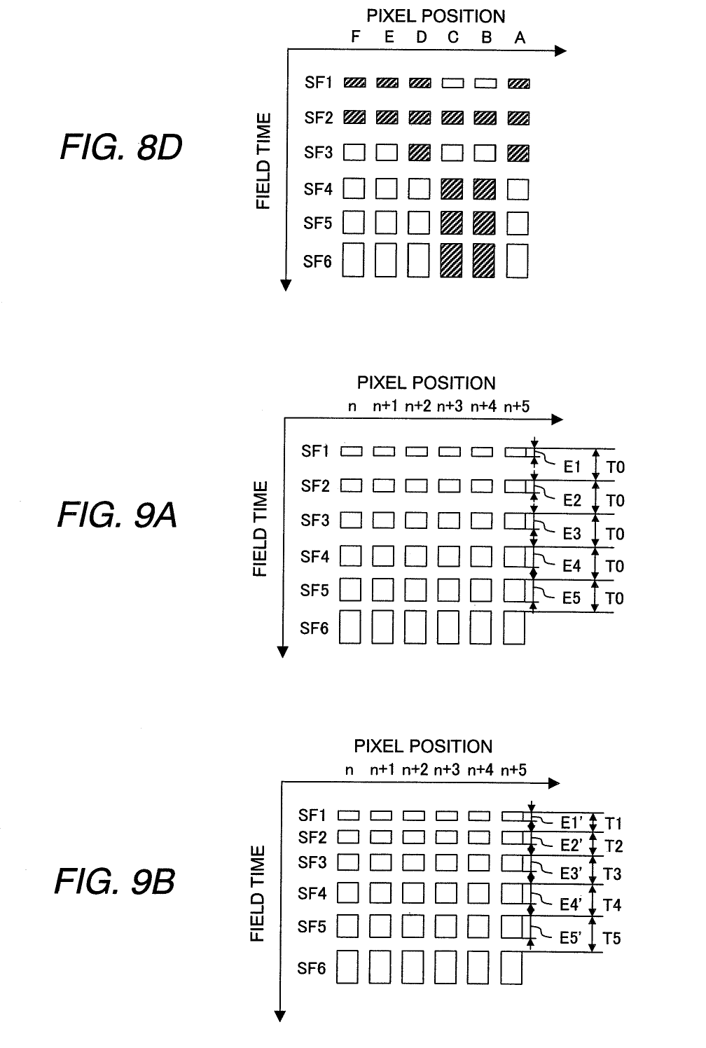

FIGS. 8A to 8D show an example display pattern according to the present embodiment. FIG. 8A shows pixels on a two-dimensional plane. FIG. 8B shows an emitting/non-emitting state of each subfield of each of pixels A to F.

Assume that, as shown in FIG. 8A, each motion vector ending at one of pixels A to G among the pixels of a field to be rearranged extends from the pixel positioned at (−6, −6) relative to the pixel at which the motion vector ends. In this case, every one of such motion vectors has a vector value of (6, 6). The pixel position vector Xi for each subfield of each pixel to be rearranged is calculated based on a corresponding motion vector and using the procedure shown in FIG. 3 and equation 1 as follows.

FIG. 8A shows an example case in which pixel A is to be rearranged. The pixel position vector Xi of SF3 of pixel A initially determined using equation 1 is (−2, −2). Since, however, the brightness difference between pixel C indicated by the pixel position vector (−2, −2) and pixel A to be rearranged is larger than a threshold value, the pixel to be compared for brightness with pixel A is changed, as shown by arrows 8011 in FIG. 8A, from pixel C to pixel H, to pixel B, and to pixel I in accordance with the procedure shown in FIG. 3. Consequently, the pixel position vector Xi of SF3 is changed to (0, 0). A similar process is followed also for pixel B indicated by the initial pixel position vector Xi (−1, −1) of SF2. Namely, as done for SF3 as described above, the pixel to be compared for brightness with pixel A is changed, as shown by arrows 8011 in FIG. 8A, from pixel B to pixel I, and, consequently, the pixel position vector Xi of SF2 is changed to (0, 0). For other subfields, i.e. SF6, SF5, and SF4, the pixel position vector Xi determined for each subfield by using equation 1 is applied as it is, because the brightness difference between each of the pixels indicated by the corresponding pixel position vectors Xi and pixel A is smaller or equal to the threshold value. Thus, the pixel position vectors Xi of the subfields of pixel A to be rearranged are determined to be (−5, −5) for SF1, (−4, −4) for SF5, (−3, −3) for SF4, and (0, 0) for SF3, SF2, and SF1 as shown in FIG. 8C.

FIG. 8D shows the result of subfield rearrangement carried out using the pixel position vectors Xi determined for pixels A to F by using the procedure shown in FIG. 3 and equation 1. Pixels A to C shown in FIG. 8D are not much different in subfield emission arrangement from the corresponding pixels, representing an original image, shown in FIG. 8B. Hence, false colors are not generated, and the generation of false contours can be inhibited.

According to the first embodiment described above, an object field can be rearranged into a new field. Rearranging one object field after another makes it possible to generate plural new fields to display an image.

According to the first embodiment described above, subfields can be rearranged taking a viewer's line-of-sight path into consideration by using motion vectors. This makes it possible to inhibit moving image blurring and the generation of dynamic false contours. It is also possible to prevent the occurrence of subfields left with no emission data set. Furthermore, the subfields to be rearranged are rearranged using only subfields of similar colors to them, and subfields of largely differing colors are not used. The rearranged subfields, therefore, do not show false colors, so that the generation of false contours can be inhibited. These advantageous effects can be realized while reducing the amount of processing to be performed by electronic circuits.

### Embodiment 2

A second embodiment of the present invention provides a display method in which the intervals between subfield emission start times are variable, as shown in FIG. 9B, with subfield emission periods taken into consideration.

Referring to FIG. 9B, subfield emission start time intervals T1, T2, T3, T4, and T5 are varied according to the corresponding subfield emission periods E1′, E2′, E3′, E4′, and E5′. Varying the subfield emission start time intervals according to the subfield emission periods means, for example, that the subfield emission start time intervals T1, T2, T3, T4, and T5 are determined by function values using the subfield emission periods E1′, E2′, E3′, E4′, and E5′ as variables, respectively. In this embodiment, therefore, unlike in the first embodiment, the subfield emission start time intervals T1, T2, T3, T4, and T5 are not uniform.

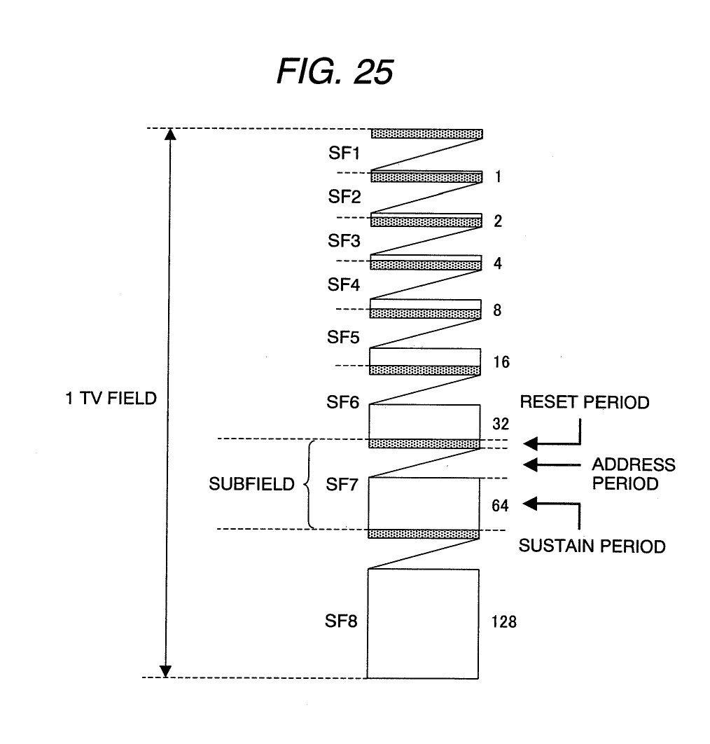

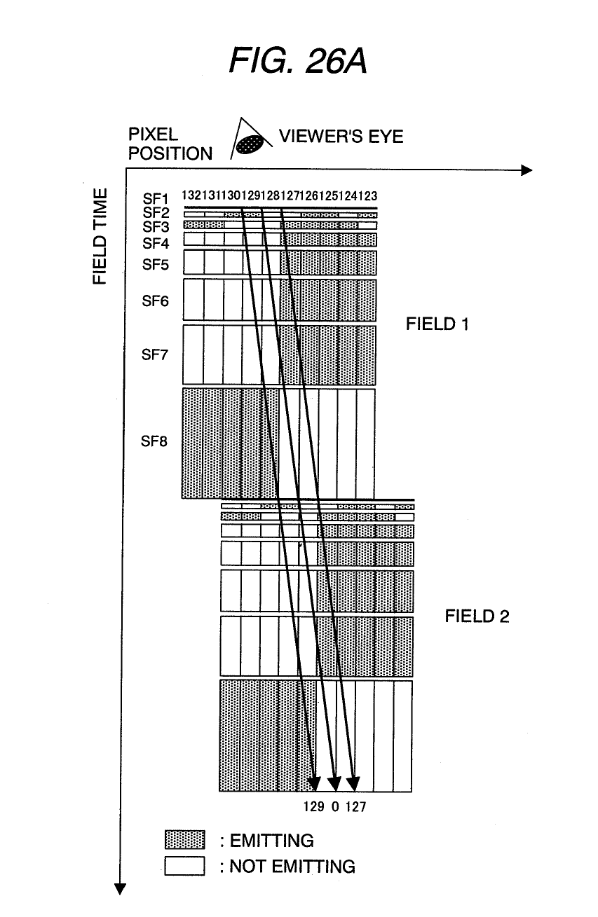

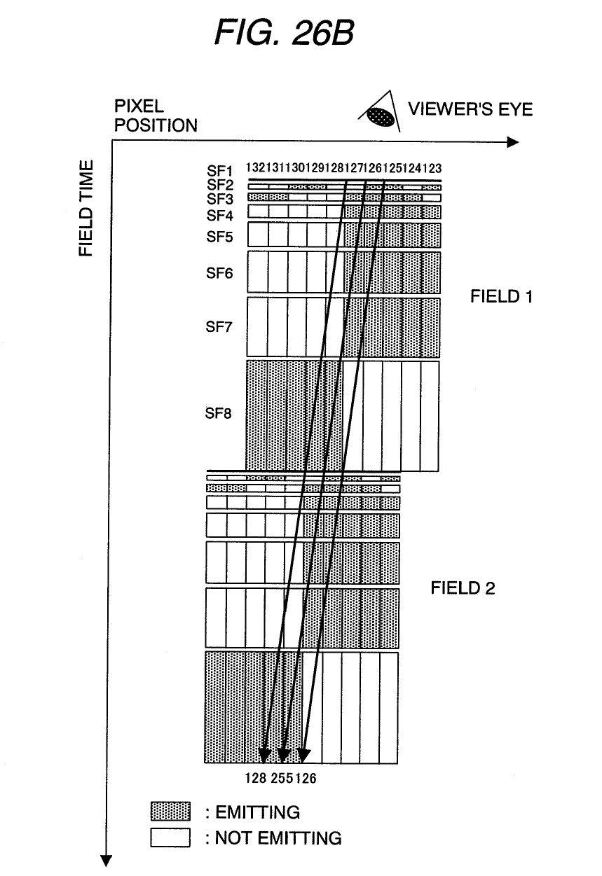

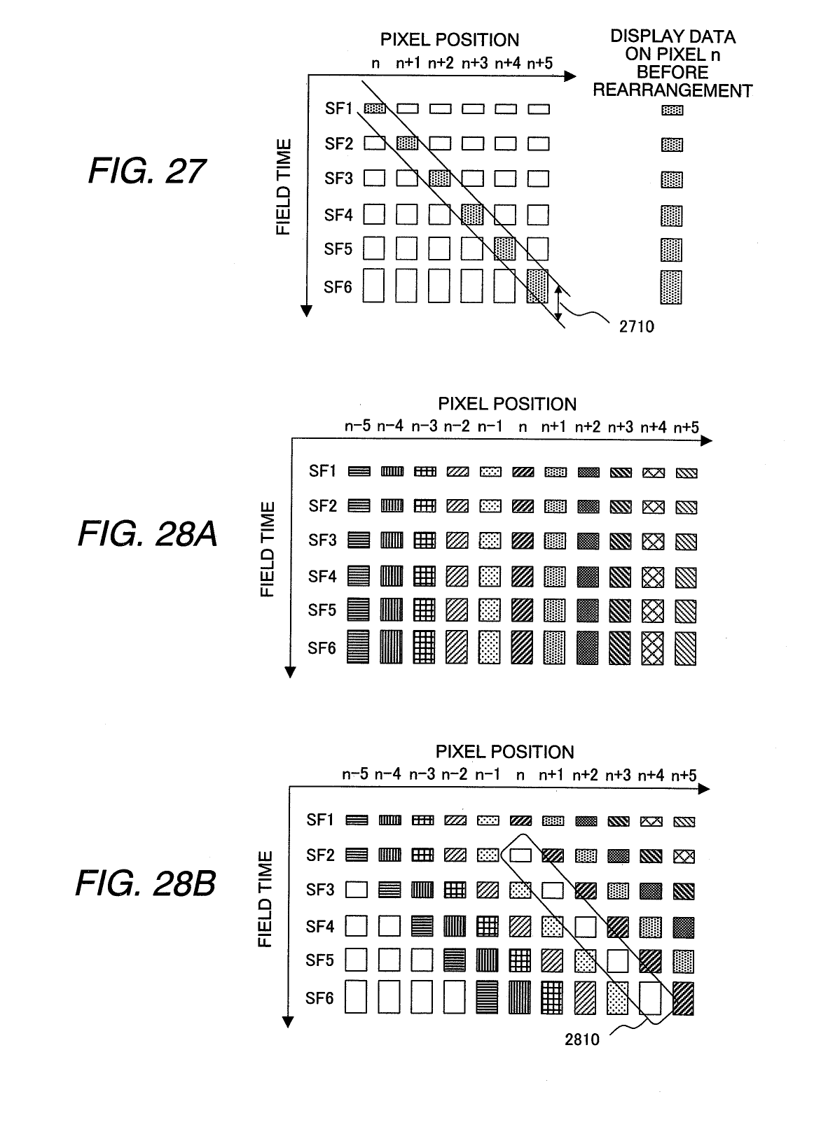

The significance of varying the emission start time intervals is as follows. There are cases in which processing to make power consumption constant is performed for a display apparatus, for example, a plasma TV which displays an image of each field by controlling subfield emission on and off. When such processing is performed, the emission start time varies relatively between subfields according to the input image display load factor. The display load factor is a parameter used, for example, when adjusting a sustain period according to a screen brightness parameter, for example, average screen brightness. Power consumption can be made uniform, for example, by shortening the sustain period, shown in FIG. 25, when the display load factor is large and lengthening the sustain period when the display load factor is small. Thus, using a display method in which the intervals between the emission start times of subfields can be varied can realize uniform power consumption.

When the display load changes depending on, for example, the average screen brightness, the direction of the viewer's line of sight inclines. This will be explained in the following. When the viewer is viewing a still image, his or her line of sight stays on the same pixels without moving even after a subfield period ends. Assume that, in such a state, the inclination of the direction of the viewer's line of sight is 0.

When a moving image is viewed, the inclination of the direction of the viewer's line of sight is affected by the image display as follows. When the display load is large, the emission period of each subfield becomes shorter. In such a state, the display apparatus makes the subfields of each TV field sequentially emit light earlier. That is, within each TV field, the subfield emission start times are advanced. This reduces the inclination of the direction of the viewer's line of sight. When the display load is small, the emission period of each subfield becomes longer. In such a state, within each TV field of the display apparatus, the subfield emission start times are put back. This increases the inclination of the direction of the viewer's line of sight.

The following explanation is based on a case where, compared with cases where the subfields sequentially start emission at regular intervals within each field, a heavy display load causes the subfields to start emission earlier thereby causing the inclination of the direction of the viewer's line-of-sight (line-of-sight path) to be reduced.

When varying the intervals between subfield emission start times, it is advisable to prepare, for example, plural tables, like Table 1 shown below specifying “subfield emission start times at variable intervals,” for plural average brightness levels. With such tables prepared, determining beforehand the average brightness level of a moving image to be displayed makes it possible to dynamically determine, without delay, the subfield emission intervals varying with the image display load factor. This makes it possible to reduce the circuit size of the display apparatus.

TABLE 1

| | Subfield | | | | | |
|---|---|---|---|---|---|---|
| | SF1 | SF2 | SF3 | SF4 | SF5 | SF6 |
| (1) Subfield | 1.0900 | 3.5905 | 6.0910 | 8.5915 | 11.0920 | 13.5925 |
| emission | | | | | | |
| start times | | | | | | |
| at regular | | | | | | |
| intervals | | | | | | |
| (ms) | | | | | | |
| (2) Subfield | 1.0900 | 3.3100 | 5.5500 | 7.9600 | 10.2700 | 12.7000 |
| emission | | | | | | |
| start times | | | | | | |
| at variable | | | | | | |
| intervals | | | | | | |
| (ms) | | | | | | |

In the following, subfield rearrangement carried out according to the second embodiment will be described based on a case where the emission start times of the subfields within each field display period (16.67 ms for 60-Hz image display) are as specified for (2) in Table 1.

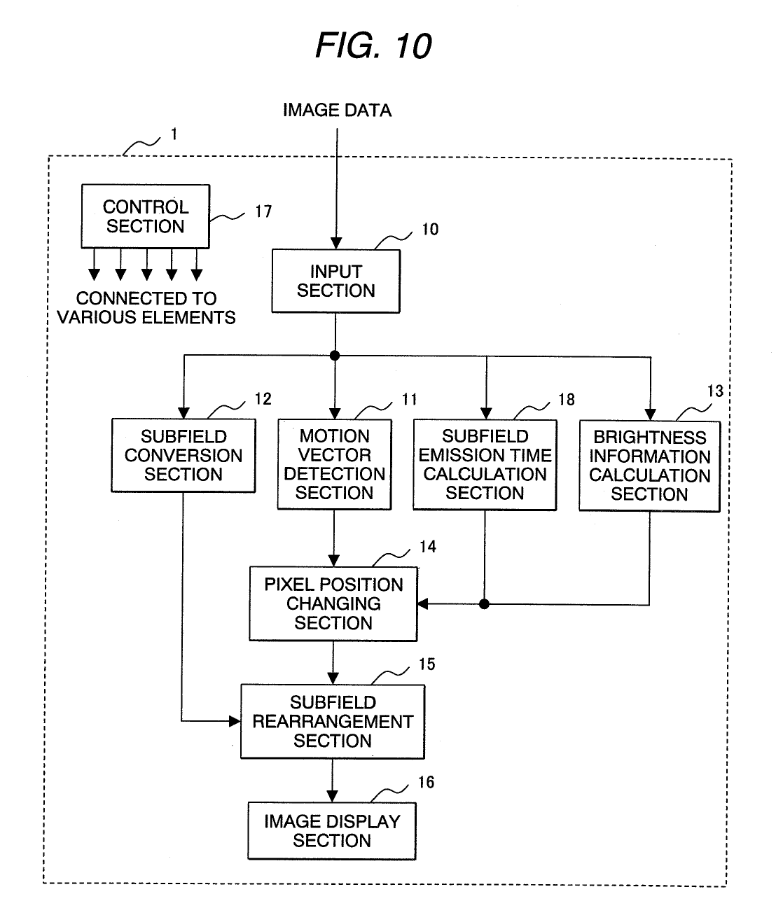

FIG. 10 is a block diagram of an example image display apparatus according to the second embodiment of the present invention. An image display apparatus 1 shown in FIG. 10 has the same sections as the image display apparatus described in the first embodiment (see FIG. 1), and it is additionally provided with a subfield emission period calculation section 18. Of the sections shown in FIG. 10, those also shown in FIG. 1 operate in the same manners as those shown in FIG. 1.

The operation of each section of the image display apparatus 1 will be described below in detail. Moving image data is inputted to the input section 10 where the moving image data is converted into display data. In the motion vector detection section 11, motion vectors respectively ending at pixels in an object field are detected by comparing the display data in the object field and the display data in a field preceding the object field. In the subfield conversion section 12, the display data is converted into subfield data. In the subfield emission period calculation section 18, the emission start time of each subfield that varies with the image display load factor is calculated. In the brightness information calculation section 13, brightness information is calculated based on the image data inputted to the input section 10.

In the pixel position changing section 14, a pixel position vector indicating the pixel a subfield of which is to be used to rearrange an object subfield of an object pixel is calculated. This is done by using, for example, out of the motion vectors detected in the motion vector detection section 11, the one ending at the pixel to be rearranged of the object field, the brightness information calculated in the brightness information calculation section 13, the emission start time of each subfield calculated in the subfield emission period calculation section 18, and the TV field period as parameters. In the subfield rearrangement section 15, out of the subfield data outputted from the subfield conversion section 12, the subfield emission data on the pixel indicated by the pixel position vector obtained in the pixel position changing section 14 is obtained. The emission data thus obtained is set on the subfield to be rearranged of the pixel to be rearranged. By repeating this process, the subfields of each pixel to be rearranged are rearranged using the subfield data outputted from the subfield conversion section 12.

The image display section 16 has plural pixels which can emit light and displays an image by controlling the light emission of each of the plural pixels on and off based on the subfield data obtained in the subfield rearrangement section 15. The control section 17 is connected to various elements of the display apparatus. The elements of the display apparatus operate according to the autonomous operations of the above-described sections or according to instructions from the control section 17.

As described above, in the display apparatus according to the present embodiment, the subfield emission period calculation section 18 calculates the emission start time of each subfield that varies with the image display load factor, and the pixel position changing section 14 calculates the pixel position vectors used to rearrange the subfields of each pixel to be rearranged based on the emission start times calculated in the subfield emission period calculation section 18 and the brightness information calculated in the brightness information calculation section 13.

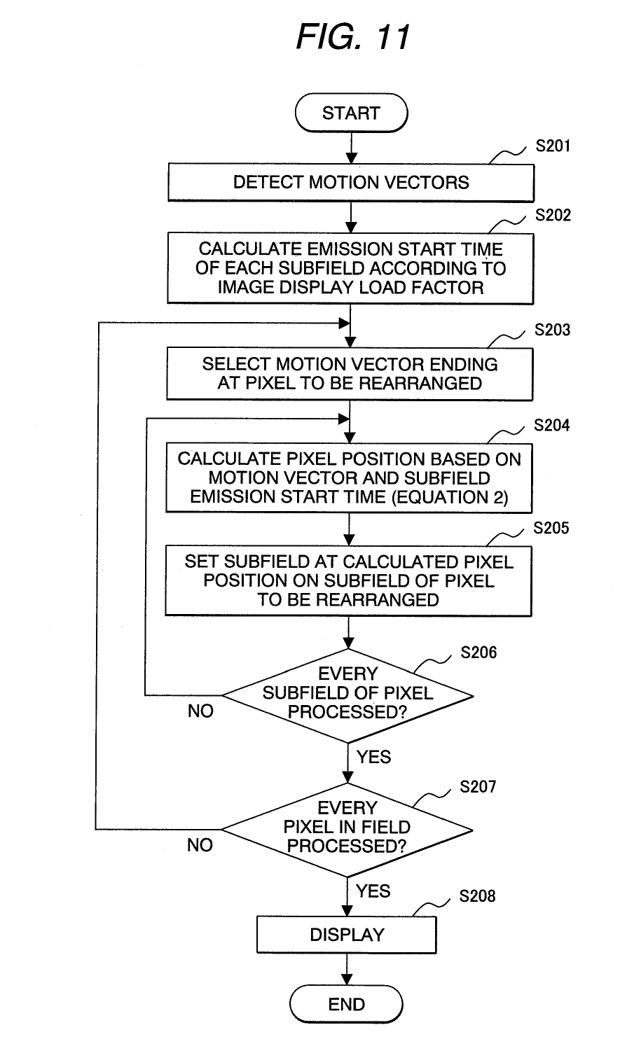

FIG. 11 is a flowchart of the image display method according to the second embodiment.

In step 201, the motion vector detection section 11 compares the display data in an object field and the display data in a field preceding the object field. Based on the comparison results, the motion vector detection section 11 detects a motion vector extending from a pixel in the preceding field to a pixel in the object field. This is done for every pixel in the object field.

In step 202, the subfield emission period calculation section 18 calculates the emission start time of each subfield that varies with the image display load factor by referring to Table 1 containing information about the emission start time of each subfield according to the average brightness level.

In step 203, out of the motion vectors detected in step 201, the one ending at an object pixel is selected.

In step 204, the pixel position changing section 14 determines, for a subfield to be rearranged of the object pixel of the object field, a pixel position vector indicating the subfield to be acquired for subfield rearrangement. This is done by using the motion vector selected in step 203 and the emission start time of the object subfield calculated in step 202 as parameters and also using the procedure shown in FIG. 3 and a computing equation (for example, equation 2).

In step 205, the subfield rearrangement section 15 sets the emission data obtained from the subfield indicated by the pixel position vector on the object subfield of the pixel to be rearranged of the object field.

In step 206, whether every subfield of the pixel to be rearranged has been rearranged is determined. When every subfield is determined to have been rearranged, the procedure advances to step 207; otherwise, the procedure returns to step 204 to repeat steps 204 and 205 for the remaining subfields yet to be rearranged.

In step 207, whether every subfield of every pixel in the object field has been rearranged is determined. When every subfield of every pixel is determined to have been rearranged, the procedure advances to step 208; otherwise the procedure returns to step 203 to repeat steps 203 to 206 for the remaining pixels.

In step 208, the image display section 16 displays the display data in the object field obtained in step 207.

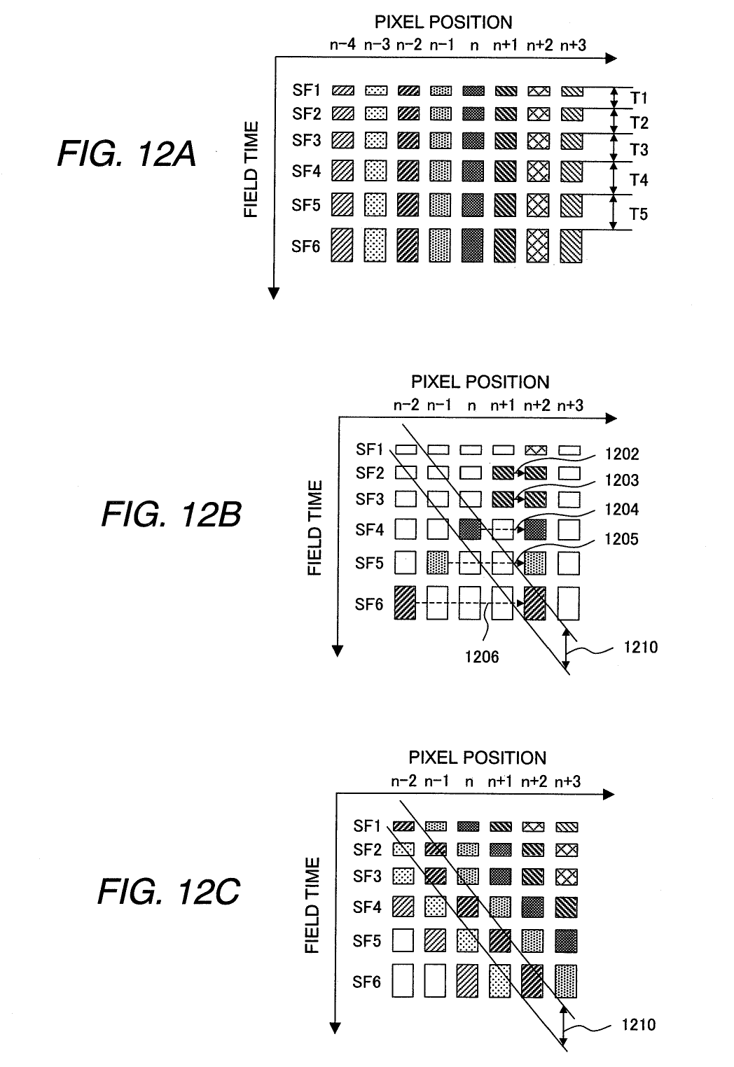

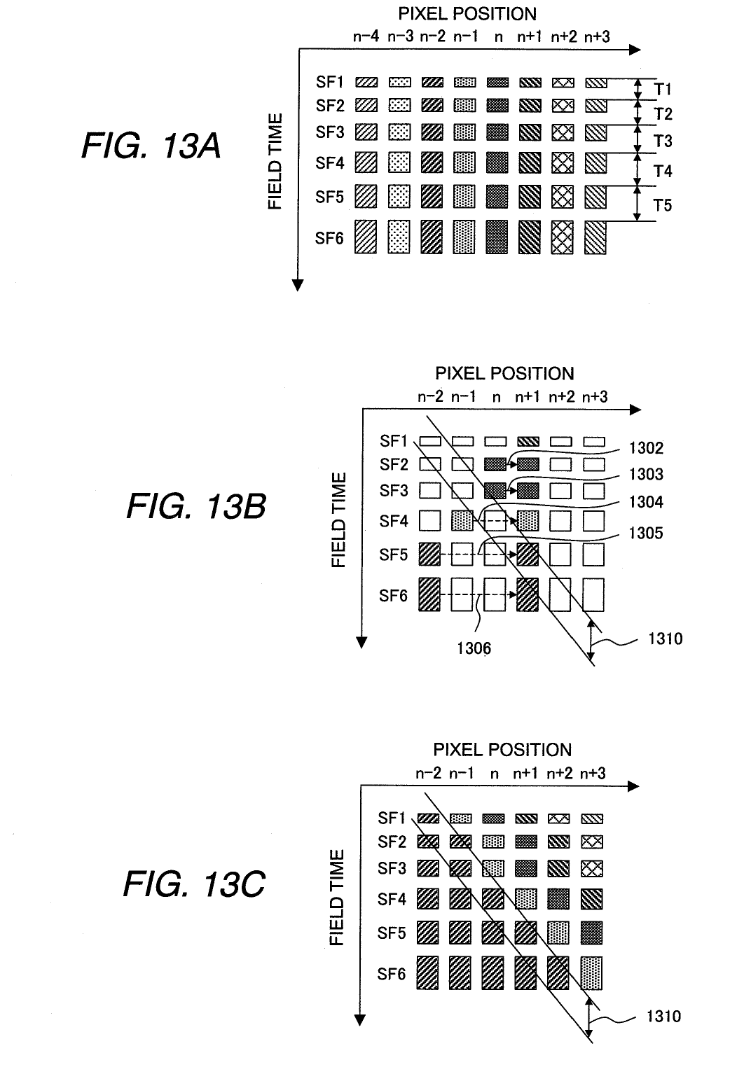

FIGS. 12A to 12C and 13A to 13C are diagrams showing examples of subfield rearrangement according to the present embodiment. The method of subfield rearrangement according to the present embodiment differs between a case where the brightness difference between pixels is smaller than or equal to a threshold value and a case where the brightness difference between pixels is larger than the threshold value. Subfield rearrangements in both cases will be described below.

With reference to FIGS. 12A to 12C, subfield rearrangement made in a case where the brightness difference between pixels is smaller than or equal to a threshold value, i.e. subfield rearrangement for a similar-color area, will be described below. FIG. 12A shows a subfield arrangement before being rearranged. In this case, it is assumed that the brightness difference between pixels ranging from (n−4) to (n+3) is smaller than or equal to a threshold value.

In the present embodiment, the process shown in FIG. 3 is carried out as follows. In step 111, a motion vector is assigned to variable A, and a subfield emission start time is assigned to variable B. In step 112, whether variable B is equal to the number of subfields is determined. In the present case, variable B represents a subfield emission start time, so that, in step 114, a pixel position vector Xi (x, y) for acquiring a required subfield is determined based on the motion vector represented by variable A and the subfield emission start time represented by variable B. In step 115, whether the brightness difference between the pixel indicated by the pixel position vector Xi (x, y) determined in step 114 and the pixel to be rearranged is either smaller than or equal to a threshold value is determined. In the present case, the brightness difference between pixels ranging from (n−4) to (n+3) is smaller than or equal to the threshold value, so that the procedure advances to step 116 where the determined pixel position vector X1 (x, y) is outputted.

The process performed in step 114 shown in FIG. 3 will be described in detail below.

With reference to FIGS. 12A to 12C, assume that a motion vector ending at an object pixel, e.g. (n+2), to be rearranged extends from a pixel positioned at horizontally −6 relative to pixel (n+2). Hence, in this case, the motion vector value is +6.

In the present example, the emission start time intervals between subfields are variable intervals with the subfield emission periods taken into consideration as specified for (2) in Table 1. In this case, the pixel position of each subfield to be acquired for subfield rearrangement is determined based on the pixel to be rearranged and using equation 2 shown below.

Xi=−V×Si/Tf (Equation 2)

where: Xi represents the pixel position vector, based on a pixel to be rearranged, of a subfield to be acquired for subfield rearrangement; i represents the subfield number of a subfield to be rearranged; and V represents a motion vector value. In the present embodiment, the motion vector value V is of a motion vector which, being among the motion vectors extending between a field to be rearranged and a field preceding the field to be rearranged, extends from a pixel of the preceding field to the pixel to be rearranged of the field to be rearranged. In the example shown in FIGS. 12A to 12C, the vector value V is +6 as mentioned above, so that the motion vector of +6 is used in rearranging each subfield of the pixel to be rearranged. Also in the above equation, Si represents the emission start time of the i-th subfield, for example, one of the values specified for (2) in Table 1, and Tf represents one TV field period.

The value of parameter Si representing the emission start time of each subfield in equation 2 can be varied according to the emission period of the subfield. The parameter, therefore, makes it possible to carry out subfield rearrangement taking into consideration the emission period of each subfield.

In the present embodiment, out of the motion vectors extending between a field to be rearranged and a field preceding the field to be rearranged, one extending from a pixel of the preceding field to a pixel to be rearranged of the field to be rearranged is selected, a pixel position vector is calculated for each subfield to be rearranged using equation 2, and the subfield is rearranged. The process will be described below.

With reference to FIG. 12B, subfield rearrangement for pixel (n+2) will be described below. The motion vector ending at pixel (n+2) to be rearranged extends from a pixel positioned at horizontally −6 relative to pixel (n+2), i.e. the motion vector value is +6. The pixel position vector Xi of each subfield of pixel (n+2) can be calculated using equation 2. The pixel position vector Xi is −4 for SF6, −3 for SF5, −2 for SF4, −1 for SF3, −1 for SF2, and 0 for SF1.

In this case, therefore, SF6 obtains subfield emission data from pixel (n−2) as shown by arrow 1206 in FIG. 12B; SF5 obtains subfield emission data from pixel (n−1) as shown by arrow 1205; SF4 obtains subfield emission data from pixel n as shown by arrow 1204; SF3 obtains subfield emission data from pixel (n+1) as shown by arrow 1203; SF2 obtains subfield emission data from pixel (n+1) as shown by arrow 1202; and SF1 remains unchanged with its emission data on pixel (n+2). In this way, the subfield emission data is rearranged for the subfields of pixel (n+2).

FIG. 12C shows the result of emission data rearrangement carried out for every one of the pixels to be rearranged ranging from (n−2) to (n+3). This example assumes that the motion vectors each ending at a pixel of the field to be rearranged have a same value, +6. The same as done for pixel (n+2) as described above, a pixel position vector Xi is calculated for each subfield of each pixel to be rearranged using equation 2. Subsequently, each subfield of each of the pixels (n−2) to (n+3) is rearranged using the subfield at the pixel position indicated by the corresponding pixel position vector Xi. When the rearrangement is finished, each set of plural subfields associated with a same pixel for a still picture (i.e. each set of subfields identically patterned in FIG. 12A) are aligned along a line-of-sight path 1210. The line-of-sight path 1210 is less inclined than the line-of-sight path 4010 shown in FIGS. 4B and 4C. This is because the subfields shown in FIGS. 12B to 12C emit light at variable intervals such that they start emission earlier than the corresponding subfields emitting light at regular intervals.

With reference to FIGS. 13A to 13C, subfield rearrangement made in a case where the brightness difference between pixels is, depending on the pixels compared, larger than a threshold value, i.e. subfield rearrangement for a non-similar-color area will be described below.

FIG. 13A shows a subfield arrangement before being rearranged. In this case, it is assumed that, whereas the brightness difference between pixels (n−4) and (n−3) and between pixels ranging from (n−2) to (n+3) is smaller than or equal to a threshold value, the brightness difference between pixels (n−3) and (n−2) is larger than the threshold value.

FIG. 13B shows the result of subfield rearrangement made for pixel (n+1). The motion vector ending at pixel (n+1) to be rearranged extends from a pixel positioned at horizontally −6 relative to pixel (n+1), i.e. the motion vector value is +6. The pixel position vector Xi of each subfield of pixel (n+1) is calculated, using equation 2, as in step 114 shown in FIG. 3. The values of pixel position vectors Xi thus calculated are −4 for SF6, −3 for SF5, −2 for SF4, −1 for SF3, −1 for SF2, and 0 for SF1.

Subsequently, the brightness differences between pixels are checked. For subfield SF6, for example, a pixel position vector Xi (−4, 0) is obtained in step 114. Next, in step 115, the brightness difference between pixels (n−3) and (n+1) is checked. Since the brightness difference between pixels (n−3) and (n+1) is larger than the threshold value, the procedure advances to step 117. Since the value of x determined in step 114 is −4, the procedure advances from step 117 to step 119, then to step 124. In step 124, the value of x is incremented by 1 to −3, then the procedure returns to step 115 to check the brightness difference between pixels (n−2) and (n+1). Since the brightness difference between pixels (n−2) and (n+1) is smaller than or equal to the threshold value, the procedure advances to step 116. In step 116, the pixel position vector Xi of SF6 corrected from (−4, 0) to (−3, 0) is outputted. Pixel position vectors Xi for the other subfields are also calculated in a similar manner. The values of pixel position vectors Xi thus calculated are −3 for SF5, −2 for SF4, −1 for SF3, −1 for SF2, and 0 for SF1.

In the present case, therefore, SF6 obtains subfield emission data from pixel (n−2) as shown by arrow 1306 in FIG. 13B; SF5 obtains subfield emission data from pixel (n−2) as shown by arrow 1305; SF4 obtains subfield emission data from pixel (n−1) as shown by arrow 1304; SF3 obtains subfield emission data from pixel n as shown by arrow 1303; SF2 obtains subfield emission data from pixel n as shown by arrow 1302; and SF1 remains unchanged with its emission data on pixel (n+1). In this way, the subfield emission data is rearranged for the subfields of pixel (n+1).

FIG. 13C shows the result of emission data rearrangement carried out for every pixel to be rearranged. This example assumes that the motion vectors each ending at a pixel of the field to be rearranged have a same value, +6. The same as done for pixel (n+1) as described above, a pixel position vector Xi is calculated for each subfield of each pixel to be rearranged using the procedure shown in FIG. 3 and equation 2. Subsequently, each subfield of each of pixels (n−2) to n, (n+2), and (n+3) is rearranged using the subfield at the pixel position indicated by the corresponding pixel position vector Xi. Consequently, when pixels (n−2) to (n+3) have been rearranged, their subfields are arranged along a line-of-sight path 1310. The subfields acquired for use in rearranging the pixels are of similar colors to those of the subfields of the pixels to be rearranged. In other words, the pixels are rearranged without using subfields of largely differing colors. The rearranged subfields, therefore, do not show false colors even outside a similar-color area. This makes it possible to inhibit the generation of false contours.

In the second embodiment as in the first embodiment, motion vectors each ending at a pixel to be rearranged are determined, and the subfields of each pixel to be rearranged are rearranged. In this way, it is possible to prevent the occurrence of subfields left without being rearranged. These advantageous effects of the present embodiment are the same as those realized by the first embodiment.

In the present embodiment, subfield rearrangement is carried out using a line-of-sight path determined based on motion vectors and subfield emission intervals. Therefore, plural subfields which would be arranged on a same pixel for a still picture can be rearranged along a line-of-sight path. In the present embodiment, such subfield rearrangement is carried out using motion vectors and subfield emission intervals as parameters. Therefore, even in cases where subfield emission intervals are variable, the subfields can be rearranged into an emission pattern better aligned along the viewer's line-of-sight path. This makes it possible to inhibit moving image blurring and the generation of dynamic false contours.

In carrying out such subfield rearrangement, making use of tables which provide information on subfield emission times for different average brightness levels can reduce the amount of processing to be performed to calculate subfield emission intervals varying with the image display load factor. It is then possible to reduce the amount of arithmetic processing to be performed for subfield rearrangement.

According to the second embodiment described above, even in cases where subfield emission start times are varied according to the image display load factor, a line-of-sight path along which the viewer can better trace an image displayed by light emitting subfields can be calculated. Since subfields can be rearranged based on such a line-of-sight path, moving image blurring and the generation of dynamic false contours can be better inhibited. Furthermore, it is possible to prevent subfields to be rearranged from being left without being rearranged. Still furthermore, the subfields to be rearranged are rearranged using only subfields of similar colors to them, and subfields of largely differing colors are not used. The rearranged subfields, therefore, do not show false colors. This makes it possible to inhibit the generation of false contours. Still furthermore, the amount of arithmetic processing to be performed to carry out such subfield rearrangement can be reduced.

The above described example of subfield rearrangement is based on a case where the subfields of each field sequentially emit light earlier than in cases where the subfields of each field sequentially emit light at regular intervals. The same advantageous effects as those obtained in the above example can be obtained, by rearranging subfields using equation 2 also in cases where the subfields of each field sequentially emit light later than when the subfields of each field sequentially emit light at regular intervals, causing the inclination of the line-of-sight path to increase.

### Embodiment 3

In a third embodiment of the present invention, to rearrange subfield data for a current field, an intermediate field is generated between the current field and a preceding field, then the subfield data for the object field is rearranged using motion vectors F each extending from a pixel of the preceding field to a pixel of the intermediate field. In the third embodiment, as in the first embodiment, the subfields of each field sequentially start emitting at regular intervals.

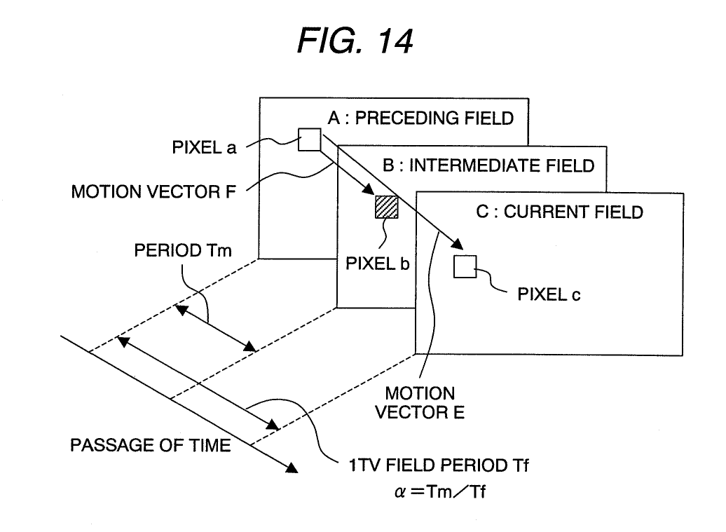

FIG. 14 is a diagram for explaining an intermediate field and a motion vector F used in the present embodiment. A motion vector F indicates, with an intermediate field B generated between a current field C and a preceding field A, the pixel of the preceding field A from which a certain pixel of the intermediate field B comes from. Namely, in FIG. 14, the motion vector F extends from pixel a of the preceding field A to pixel b of the intermediate field B.

As for how to generate, out of plural fields of an input moving image, an intermediate field and determine a motion vector F, technology disclosed in, for example, Japanese Patent Laid-Open No. 2006-310985 (see FIG. 3 thereof) can be used.

Referring to FIG. 14, a motion vector E extending from pixel a to pixel c can be determined by estimating the amount of motion based on the image pattern correlation between the current field C and the preceding field A. Where Tm represents the time distance (period) between the preceding field A and the intermediate field B; and Tf represents the time distance between the preceding field A and the current field C (TV field period), the motion vector F representing the amount of movement between pixel a and pixel b can be determined using the following equation 3.

Vf=V×Tm/Tf (Equation 3)

where Vf represents the value of the motion vector F, and V represents the value of motion vector E. The ratio α of period Tm between the beginning of one TV field and the beginning of the intermediate field B to the TV field period Tf is defined by the following equation 4.

α=Tm/Tf (Equation 4)

When the intermediate field B is positioned in the middle of the TV field between the preceding field A and the current field C, α is 0.5. Therefore, when Tm is one half of Tf (i.e. α=0.5), and the vector value V of the motion vector E is +4, the vector value Vf of the motion vector F is +2.

Regarding the value of pixel b of the intermediate field B, it is possible to obtain a function value dependent on a variable determined by the values of both pixel a of the preceding field A and pixel c of the current field C and then output pixel b of the intermediate field B to the position indicated by the motion vector F. The variable may be, for example, the average value of pixels a and c or the weighted average value of pixels a and c taking into consideration the distances between each of the preceding field A and the current field C and the intermediate field B. It is also possible to generate pixels of the intermediate field B using motion vectors E each extending from a pixel of the preceding field A to a pixel of the current field C.

According to the present embodiment, subfield rearrangement can be carried out by any of the following three methods using the motion vector F. The object field whose subfields are rearranged is dependent on the method adopted.

In the first one of the three methods, an intermediate field B generated as described above is made the object field for subfield rearrangement. In the first method, the relationship between the object field for subfield rearrangement and the motion vector F is as follows. The intermediate field B whose subfields are to be rearranged is positioned between two fields (preceding field A and current field C) of an image signal. For each pixel of the intermediate field B, a motion vector extending from a pixel of the preceding field A preceding the intermediate field B is calculated as a motion vector F. The motion vectors F thus calculated are used to rearrange the subfields of the intermediate field B. This first method in which the subfields of the intermediate field B are rearranged using the motion vectors F each ending at a pixel of the intermediate field B is theoretically the most preferable among the three methods.

In the second method, of two fields (preceding field A and current field C) of an image signal, the preceding field A is made the object field for subfield rearrangement. In the second method, the relationship between the object field for subfield rearrangement and the motion vector F is as follows. In the second method, as mentioned above, the subfields of the preceding field A that precedes the current field C are rearranged by first calculating motion vectors F in the same manner as used in the first method and then using the calculated motion vectors F. Since the preceding field A that is the object of subfield rearrangement in the second method is positioned close to the intermediate field B, a moving image obtained after subfield rearrangement carried out by the second method using the motion vectors F is comparable to one obtained by the first method. In the second method, subfield rearrangement does not involve any pixel values of the intermediate field B, so that it is not necessary to generate the pixels of the intermediate field B. Hence, an advantageous effect of the second method is that the amount of arithmetic processing to be performed for subfield rearrangement can be reduced.

In the third method, of two fields (preceding field A and current field C) of an image signal, the current field C is made the object field for subfield rearrangement. In the third method, the relationship between the object field for subfield rearrangement and the motion vector F is as follows. In the third method, as mentioned above, the subfields of the current field C that follows the preceding field A are rearranged by first calculating motion vectors F in the same manner as used in the first method and then using the calculated motion vectors F. Since the current field C that is the object of subfield rearrangement in the third method is positioned close to the intermediate field B as in the second method, a moving image obtained after subfield rearrangement carried out by the third method using the motion vectors F is comparable to one obtained by the first method. In the third method as in the second method, subfield rearrangement does not involve any pixel values of the intermediate field B, so that it is not necessary to generate the pixels of the intermediate field B. Hence, an advantageous effect of the third method is that the amount of arithmetic processing to be performed for subfield rearrangement can be reduced.

As described above, any one of the above three methods may be used, that is, any one of the above three fields may be made the object field for subfield rearrangement. Hence, the “object field” referred to in the following description of the present embodiment may be any one of the preceding field A, intermediate field B, and current field C shown in FIG. 14.

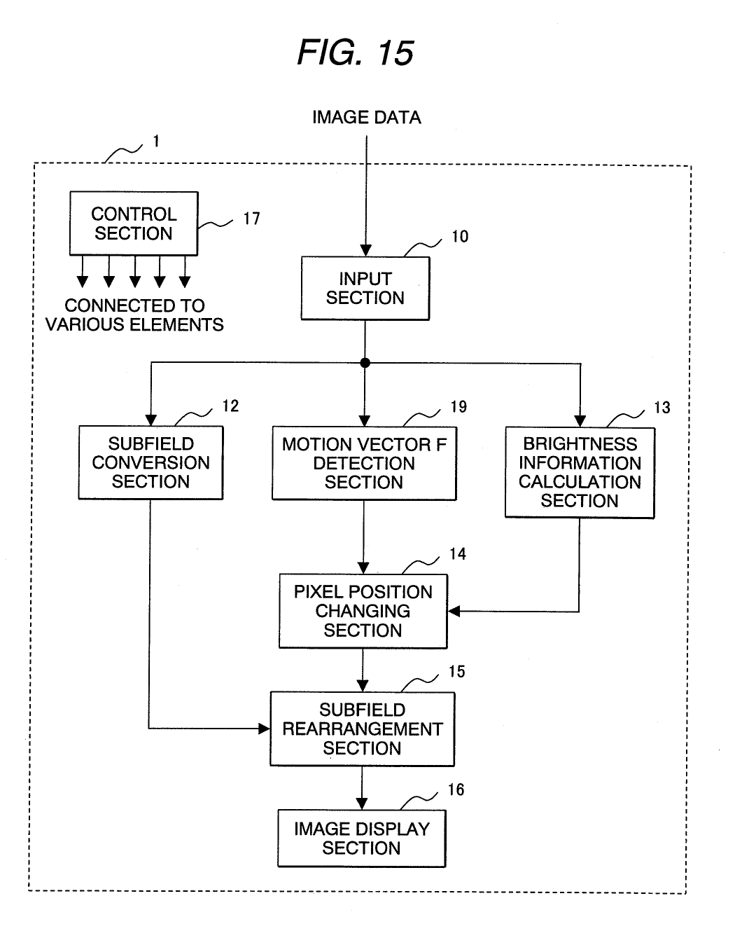

FIG. 15 is a block diagram of an example image display apparatus according to the third embodiment of the present invention. In the present embodiment, it is assumed that the subfields of each field sequentially start emission at regular intervals as shown in FIG. 9A. An image display apparatus 1 shown in FIG. 15 has the same sections as the image display apparatus described in the first embodiment (see FIG. 1) except that the motion vector detection section 11 shown in FIG. 1 is replaced by a motion vector F detection section 19. Of the sections shown in FIG. 15, those also shown in FIG. 1 operate in the same manners as those shown in FIG. 1.

The operation of each section of the image display apparatus 1 will be described below in detail. Moving image data is inputted to the input section 10 where the moving image data is converted into display data. The input section 10 also generates and outputs an intermediate field B. In the subfield conversion section 12, the display data is converted into subfield data. In the motion vector F detection section 19, the display data in the intermediate field B and the display data in a preceding field A is compared, and a motion vector F extending from a pixel in the preceding field A to a pixel in the intermediate field B is detected. This is done for every pixel in the intermediate field B. In the brightness information calculation section 13, brightness information is calculated based on the image data inputted to the input section 10. In the pixel position changing section 14, a pixel position vector indicating the pixel a subfield of which is to be used to rearrange an object subfield of an object pixel is calculated. This is done by using the corresponding one of the motion vectors F detected in the motion vector F detection section 19 and the brightness information calculated in the brightness information calculation section 13 as parameters. In the subfield rearrangement section 15, out of the subfield data outputted from the subfield conversion section 12, the subfield emission data for the pixel indicated by the pixel position vector calculated in the pixel position changing section 14 is obtained. The emission data thus obtained is set on the object subfield to be rearranged. By repeating this process, the subfields of each pixel are rearranged using the subfield data outputted from the subfield conversion section 12.

The image display section 16 has plural pixels which can emit light and displays an image by controlling the light emission of each of the plural pixels on and off based on the subfield data obtained in the subfield rearrangement section 15. The control section 17 is connected to various elements of the display apparatus. The elements of the display apparatus operate according to the autonomous operations of the above-described sections or according to instructions from the control section 17.

As described above, in the display apparatus according to the present embodiment: the motion vector F detection section 19 detects motion vectors F each extending from a pixel in the preceding field A to a pixel in the intermediate field B; and the pixel position changing section 14 calculates, to rearrange an object subfield of an object pixel using the corresponding one of the motion vectors F and the brightness information calculated in the brightness information calculation section 13, a pixel position vector indicating the pixel a subfield of which is to be used to rearrange the object subfield.

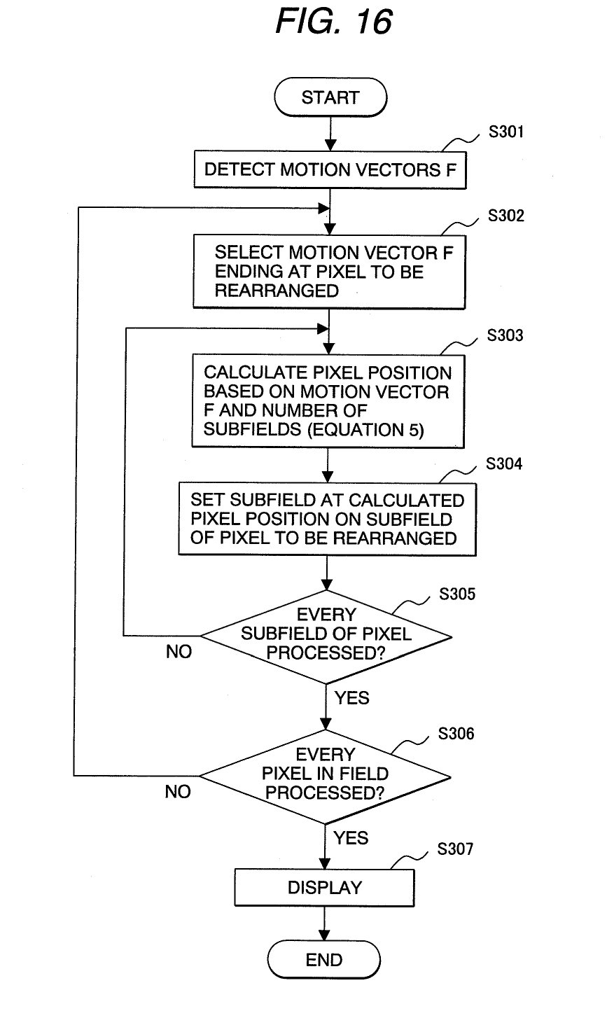

FIG. 16 is a flowchart of the image display method according to the third embodiment.

In step 301, the motion vector F detection section 19 compares the display data in the intermediate field B and the display data in the preceding field A. Based on the comparison results, the motion vector F detection section 19 detects a motion vector F extending from a pixel in the preceding field A to a pixel in the intermediate field B. This is done for every pixel in the intermediate field B.

In step 302, out of the motion vectors F detected in step 301, the one ending at an object pixel is selected.

In step 303, the pixel position changing section 14 determines, for a subfield to be rearranged of an object pixel of the object field, a pixel position vector indicating the subfield to be acquired for subfield rearrangement. This is done by using the motion vector F selected in step 302, the subfield number of the object subfield, the number of subfields, and ratio α as parameters and also using the procedure shown in FIG. 3 and a computing equation (for example, equation 5). The ratio α may be calculated in the pixel position changing section 14, or the control section 17 may calculate it by obtaining such information as the TV field period and the time distance between the beginning of one TV field and an intermediate field form memory storing such information.

In step 304, the subfield rearrangement section 15 sets the emission data obtained from the subfield indicated by the pixel position vector obtained in step 303 on the subfield to be rearranged of the object pixel of the object field.

In step 305, whether every subfield of the object pixel to be rearranged has been rearranged is determined. When every subfield is determined to have been rearranged, the procedure advances to step 306; otherwise, the procedure returns to step 303 to repeat steps 303 and 304 for the remaining subfields yet to be rearranged.

In step 306, whether every subfield of every pixel in the object field has been rearranged is determined. When every subfield of every pixel is determined to have been rearranged, the procedure advances to step 307; otherwise the procedure returns to step 302 to repeat steps 302 to 305 for the remaining pixels.

In step 307, the image display section 16 displays the display data in the object field obtained in step 306.

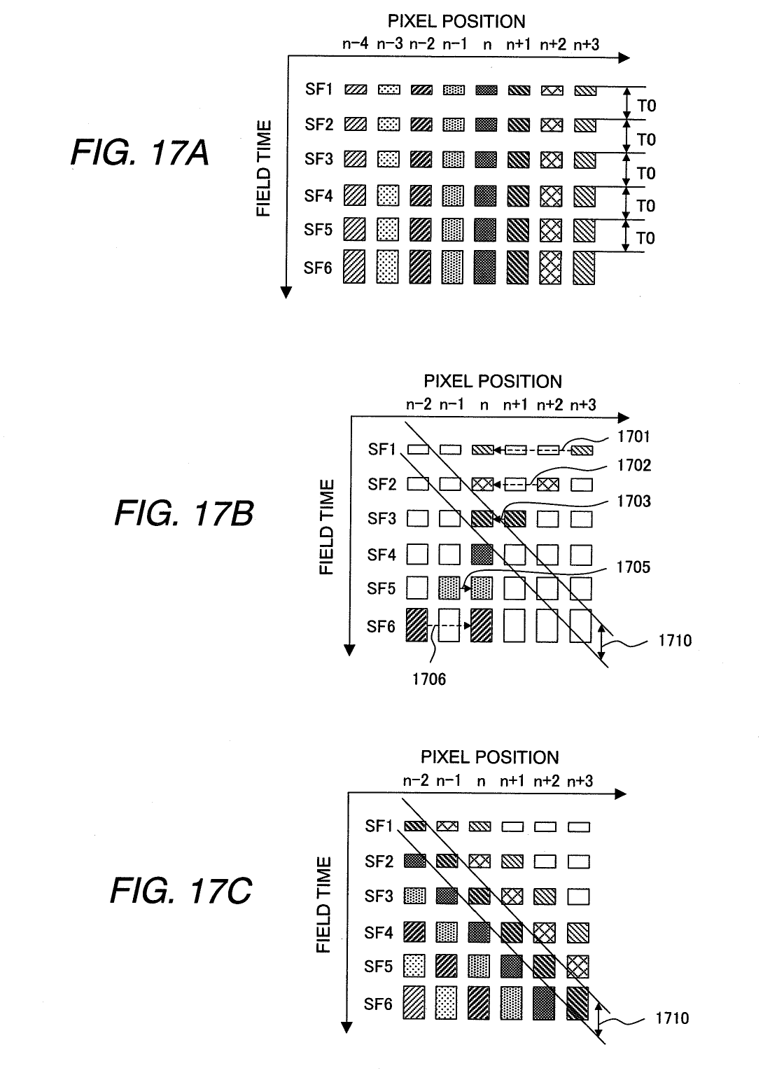

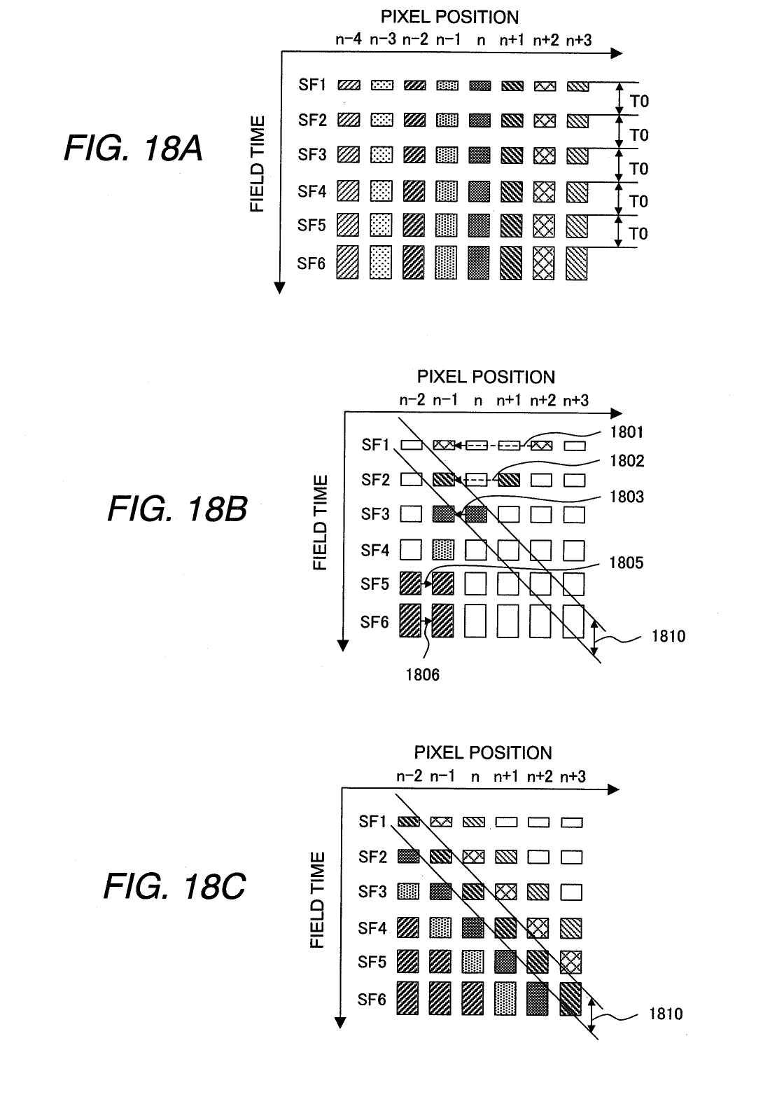

FIGS. 17A to 17C and 18A to 18C are diagrams showing examples of subfield rearrangement according to the present embodiment. The method of subfield rearrangement according to the present embodiment differs between a case where the brightness difference between pixels is smaller than or equal to a threshold value and a case where the brightness difference between pixels is larger than the threshold value. Subfield rearrangements in both cases will be described below.

With reference to FIGS. 17A to 17C, subfield rearrangement made in a case where the brightness difference between pixels is smaller than or equal to a threshold value, i.e. subfield rearrangement for a similar-color area, will be described below. FIG. 17A shows a subfield arrangement before being rearranged. In this case, it is assumed that the brightness difference between pixels ranging from (n−4) to (n+3) is smaller than or equal to a threshold value.

In the present embodiment, the process shown in FIG. 3 is carried out as follows. In step 111, a motion vector F is assigned to variable A, and the number of subfields is assigned to variable B. In step 112, whether variable B is equal to the number of subfields is determined. In the present case, variable B represents the number of subfields, so that, in step 113, a pixel position vector Xi (x, y) for acquiring a required subfield is determined based on the motion vector F represented by variable A and the number of subfields represented by variable B. In step 115, whether the brightness difference between the pixel indicated by the pixel position vector Xi (x, y) determined in step 115 and the pixel to be rearranged is either smaller than or equal to a threshold value is determined. In the present case, the brightness difference between pixels ranging from (n−4) to (n+3) is smaller than or equal to the threshold value, so that the procedure advances to step 116 where the determined pixel position vector X1 (x, y) is outputted.

The process performed in step 113 shown in FIG. 3 will be described in detail below.

With reference to FIG. 14, the present embodiment assumes concerning the motion vector E extending from pixel a of the preceding field A through pixel b of the intermediate field B to pixel c of the current field C that pixel a from which the motion vector E extends is positioned at horizontally −6 relative to pixel c at which the motion vector E ends. With reference to FIG. 14, it is also assumed that the intermediate field B is positioned in the middle (α=0.5) of the TV field period between the preceding field A and the current field C. Then, pixel a of the preceding field A from which the motion vector F extends is positioned at horizontally −3 relative to pixel b of the intermediate field B at which the motion vector F ends. In this state, vector value Vf of the motion vector F is +3.

Furthermore, in the present embodiment as in the first embodiment, the subfields of each field sequentially start emission at regular intervals.

In the present embodiment, the pixel position of each subfield to be acquired for subfield rearrangement is determined based on the pixel to be rearranged and using equation 5 shown below.

Xi=−Vf×{(i−1)−(N×α)}/(N×α) (Equation 5)

where: Xi represents the pixel position vector, based on a pixel to be rearranged, of a subfield to be acquired for subfield rearrangement; Vf represents the value of a motion vector F; i represents the subfield number of a subfield to be rearranged; N represents the number of subfields per TV field; and α represents the ratio of Tf to Tm determined by equation 4.

In the present embodiment, the value Vf is of a motion vector F which, being among the motion vectors F extending between the preceding field A and the intermediate field B, extends from a pixel of the preceding field A to a pixel to be rearranged of the intermediate field B. Each subfield of the pixel to be rearranged is rearranged using the motion vector F.

As described above, in the present embodiment, out of the motion vectors F extending between the preceding field A and the intermediate field B, one extending from pixel a of the preceding field A to pixel b to be rearranged of the intermediate field B is selected, a pixel position vector is calculated for each subfield to be rearranged using equation 5, and the subfield is rearranged. The process will be described below.

FIG. 17B shows the result of subfield rearrangement made for pixel n of an object field. The motion vector F ending at pixel n to be rearranged extends from a pixel positioned at horizontally −3 relative to pixel n, so that the value Vf of the motion vector F is +3. The pixel position vector Xi of each subfield of pixel n of the object field can be calculated using equation 5. The pixel position vector Xi calculated using equation 5 is −2 for SF6, −1 for SF5, 0 for SF4, +1 for SF3, +2 for SF2, and +3 for SF1.

Therefore, SF6 obtains subfield emission data from pixel (n−2) as shown by arrow 1706 in FIG. 17B; SF5 obtains subfield emission data from pixel (n−1) as shown by arrow 1705; SF4 remains unchanged with its emission data on pixel n; SF3 obtains subfield emission data from pixel (n+1) as shown by arrow 1703; SF2 obtains subfield emission data from pixel (n+2) as shown by arrow 1702; and SF1 obtains subfield emission data from pixel (n+3) as shown by arrow 1701. In this way, the subfield emission data is rearranged for the subfields of pixel n.

FIG. 17C shows the result of emission data rearrangement carried out for every one of the pixels to be rearranged, ranging from pixels (n−2) to (n+3). This example assumes that every motion vector F ending at a pixel to be rearranged of the intermediate field B extends from a pixel positioned, the same as in the above case of pixel n, at horizontally −3 relative to the corresponding pixel to be rearranged and that all such motion vectors F have a same value (Vf) of +3. The same as in the above case of pixel n, a pixel position vector Xi is calculated using equation 5 for every subfield of every pixel to be rearranged. Subsequently, every subfield of every pixel to be rearranged is rearranged using the subfield at the pixel position indicated by the corresponding pixel position vector Xi. Consequently, each set of plural subfields associated with a same pixel for a still picture (i.e. each set of subfields identically patterned in FIGS. 17A to 17C) are aligned along a line-of-sight path 1710.

With reference to FIGS. 18A to 18C, subfield rearrangement made in a case where the brightness difference between pixels is, depending on the pixels compared, larger than a threshold value, i.e. subfield rearrangement for a non-similar-color area will be described below.

FIG. 18A shows a subfield arrangement before being rearranged. In this case, it is assumed that, whereas the brightness difference between pixels (n−4) and (n−3) and between pixels ranging from (n−2) to (n+3) is smaller than or equal to a threshold value, the brightness difference between pixels. (n−3) and (n−2) is larger than the threshold value.

FIG. 18B shows the result of subfield rearrangement made for pixel (n−1). The motion vector F ending at pixel (n−1) to be rearranged extends from a pixel positioned at horizontally −3 relative to pixel (n−1), i.e. the motion vector value is +3. The pixel position vector Xi of each subfield of pixel (n−1) is calculated, using equation 5, as in step 113 shown in FIG. 3. The values of pixel position vectors Xi thus calculated are −2 for SF6, −1 for SF5, 0 for SF4, +1 for SF3, +2 for SF2, and +3 for SF1.

Subsequently, the brightness differences between pixels are checked. For subfield SF6, for example, a pixel position vector Xi (−2, 0) is obtained in step 113. Next, in step 115, the brightness difference between pixels (n−3) and (n−1) is checked. Since the brightness difference between pixels (n−3) and (n−1) is larger than the threshold value, the procedure advances to step 117. Since the value of x determined in step 113 is −2, the procedure advances from step 117 to step 119, then to step 124. In step 124, the value of x is incremented by 1 to −1, then the procedure returns to step 115 to check the brightness difference between pixels (n−2) and (n−1). Since the brightness difference between pixels (n−2) and (n−1) is smaller than or equal to the threshold value, the procedure advances to step 116. In step 116, the pixel position vector Xi of SF6 corrected from (−2, 0) to (−1, 0) is outputted. Pixel position vectors Xi for the other subfields are also calculated in a similar manner. The values of pixel position vectors Xi thus calculated are −1 for SF5, 0 for SF4, +1 for SF3, +2 for SF2, and +3 for SF1.

In the present case, therefore, SF6 obtains subfield emission data from pixel (n−2) as shown by arrow 1806 in FIG. 18B; SF5 obtains subfield emission data from pixel (n−2) as shown by arrow 1805; SF4 remains unchanged with its emission data on pixel (n−1); SF3 obtains subfield emission data from pixel n as shown by arrow 1803; SF2 obtains subfield emission data from pixel (n+1) as shown by arrow 1802; and SF1 obtains subfield emission data from pixel (n+2) as shown by arrow 1801. In this way, the subfield emission data is rearranged for the subfields of pixel (n−1).

FIG. 18C shows the result of emission data rearrangement carried out for every pixel to be rearranged. This example assumes that the motion vectors each ending at a pixel of the field to be rearranged have a same value, +3. The same as done for pixel (n−1) as described above, a pixel position vector Xi is calculated for each subfield of each pixel to be rearranged using the procedure shown in FIG. 3 and equation 5. Subsequently, each subfield of each of pixels (n−2) and n to (n+3) is rearranged using the subfield at the pixel position indicated by the corresponding pixel position vector Xi. Consequently, when pixels (n−2) to (n+3) have been rearranged, their subfields are arranged along a line-of-sight path 1810. The subfields acquired for use in rearranging the pixels are of similar colors to those of the subfields to be rearranged. In other words, the pixels are rearranged without using subfields of largely differing colors. The rearranged subfields, therefore, do not show false colors even outside a similar-color area. This makes it possible to inhibit the generation of false contours.

In the present embodiment as in the first embodiment, plural subfields which would be arranged on a same pixel for a still picture can be rearranged along a line-of-sight path.

Furthermore, in the present embodiment compared with the first embodiment, the distance of moving subfield emission data for subfield rearrangement can be reduced. For example, in both of the subfield rearrangement example shown in FIG. 4B for the first embodiment and that shown in FIG. 17B for the third embodiment, the vector value in the TV field period is +6. The largest distance in pixels by which emission data is moved in the example case shown in FIG. 4 for the first embodiment is five as indicated by arrow 4006, whereas it is three as indicated by arrow 1701 in the example case shown in FIG. 17B for the third embodiment. Thus, subfields can be rearranged by moving emission data by smaller distances according to the third embodiment in which equation 5 is used. Since, according to the third embodiment, the distances by which emission data is moved for subfield rearrangement can be reduced, image shaking can be inhibited to enable natural image display.

According to the third embodiment described above, subfields can be rearranged taking a viewer's line-of-sight path into consideration by using motion vectors, and moving image blurring and the generation of dynamic false contours can be inhibited. It is also possible to prevent subfields to be rearranged from being left without being rearranged. Furthermore, the distances by which subfields are moved for subfield rearrangement can be reduced. This makes it possible to inhibit image shaking and realize more natural image display. Furthermore, the subfields to be rearranged are rearranged using only subfields of similar colors to them, and subfields of largely differing colors are not used. The rearranged subfields, therefore, do not show false colors. This makes it possible to inhibit the generation of false contours. Still furthermore, the amount of arithmetic processing to be performed to carry out such field rearrangement can be reduced.

### Embodiment 4

In a fourth embodiment of the present invention, the intervals between subfield emission start times are assumed variable as in the second embodiment, and subfield data is rearranged using an intermediate field and motion vectors F as in the third embodiment.

The following description of the fourth embodiment is, the same as done for the second embodiment, based on a case where, compared with cases where the subfields of each field sequentially start emission at regular intervals, a heavy display load causes the subfields to start emission early thereby causing the inclination of the viewer's line-of-sight path to be reduced.

Also, in the fourth embodiment, the same as in the third embodiment, any one of the three methods of subfield rearrangement described for the third embodiment may be used. Namely, the “object field” referred to in the following description of the fourth embodiment may be any one of the preceding field A, intermediate field B, and current field C shown in FIG. 14.

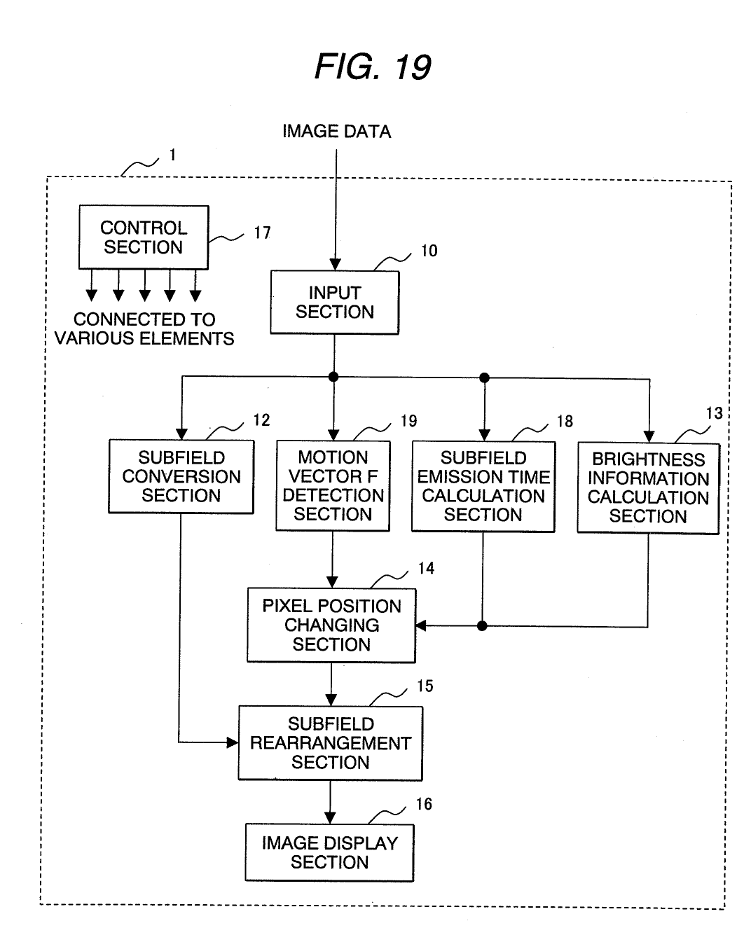

FIG. 19 is a block diagram of an example image display apparatus according to the fourth embodiment of the present invention. In the present embodiment, the intervals between subfield emission start times are variable, as shown in FIG. 9B, with subfield emission periods taken into consideration. An image display apparatus 1 shown in FIG. 19 has the same sections as the image display apparatus 1 of the first embodiment (see FIG. 1) with the motion vector detection section 11 shown in FIG. 1 replaced by a motion vector F detection section 19 and with a subfield emission period calculation section 18 additionally included. The sections shown in FIG. 19 operate in the same manners as in the first to third embodiments, so that they will not be fully described in the following.

The pixel position changing section 14 calculates a pixel position vector indicating the pixel a subfield of which is to be used to rearrange an object subfield of an object pixel. This is done by using the corresponding motion vector F detected in the motion vector F detection section 19, the emission start time of the subfield determined in the subfield emission period calculation section 18, and the brightness information calculated in the brightness information calculation section 13, and also using the procedure shown in FIG. 3 and a computing equation (equation 6).

The subfield rearrangement section 15 obtains, out of the subfield data outputted from the subfield conversion section 12, the subfield emission data of the pixel indicated by the pixel position vector determined by the pixel position changing section 14, and sets the emission data thus obtained on the object subfield of the object pixel to be rearranged. By repeating this process, the subfields of each pixel are rearranged such that they have new subfield data generated from the subfield data obtained by the subfield conversion section 12. The image display section 16 displays the subfield data thus generated.

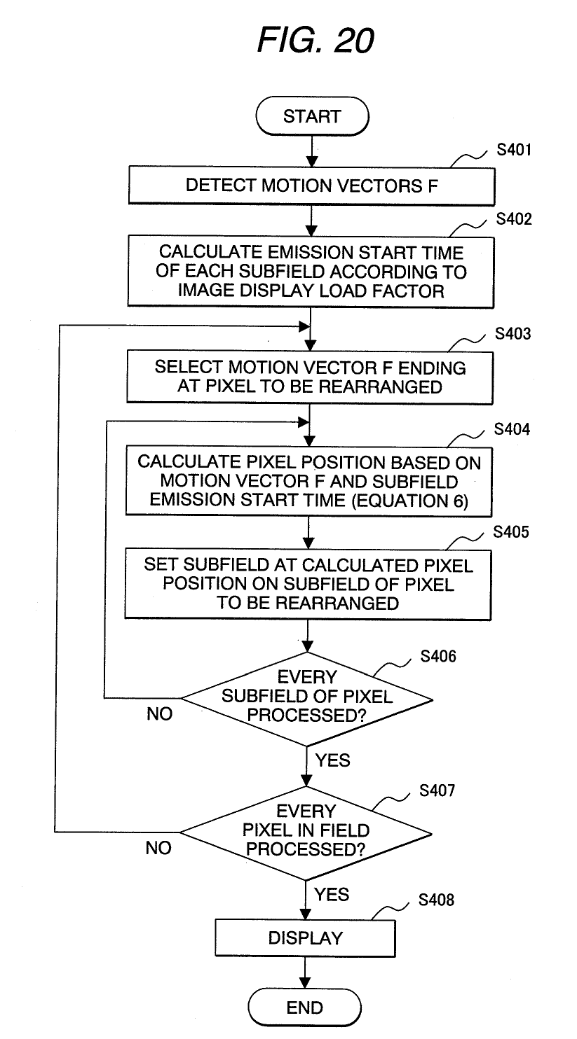

FIG. 20 is a flowchart of the image display method according to the fourth embodiment.

In step 401, the motion vector F detection section 19 detects, as done in step 301 shown in FIG. 16, a motion vector F for every pixel in the intermediate field B.

In step 402, the subfield emission period calculation section 18 calculates, as done in step 202 shown in FIG. 11, the emission start time of each subfield.

In step 403, out of the motion vectors F detected in step 401, the one ending at an object pixel is selected.

In step 404, the pixel position changing section 14 determines a pixel position vector indicating the subfield to be acquired for subfield rearrangement. This is done by using the motion vector F detected in step 401, the emission start time of the object subfield calculated in step 402, and ratio α as parameters and also using the procedure shown in FIG. 3 and a computing equation (for example, equation 6).

In step 405, the subfield rearrangement section 15 sets the emission data obtained from the subfield indicated by the pixel position vector obtained in step 404 on the object subfield of the object field.

In steps 406 and 407, a loop process similar to the one performed in steps 105 and 106 shown in FIG. 2 is performed. In step 408, the image display section 16 displays the display data in the object field obtained in step 407.

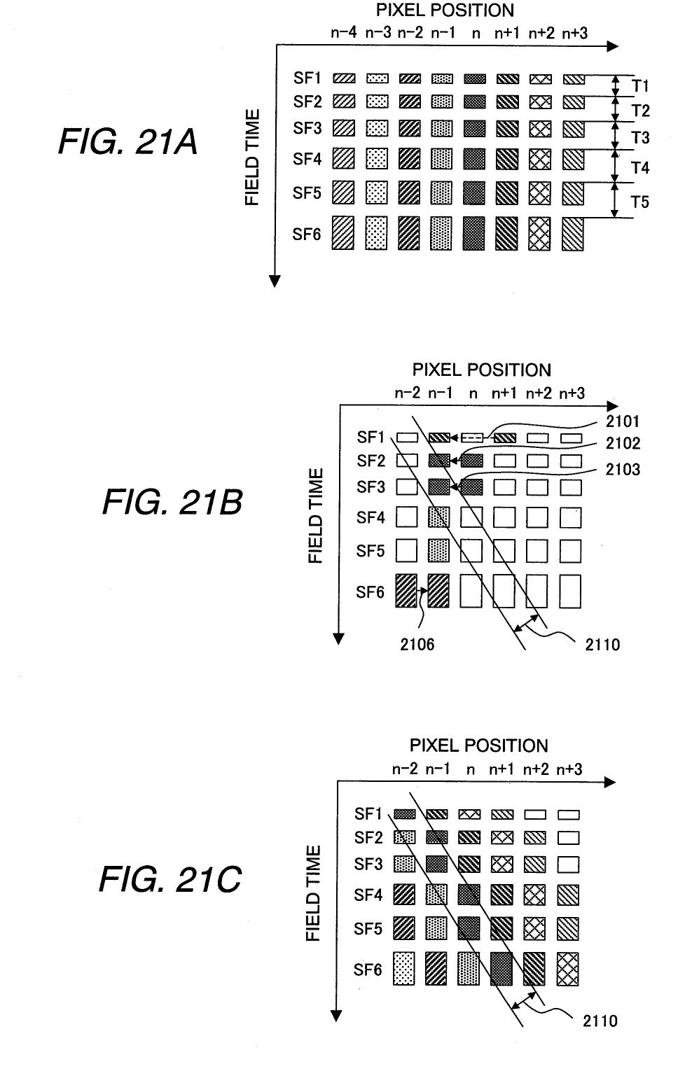

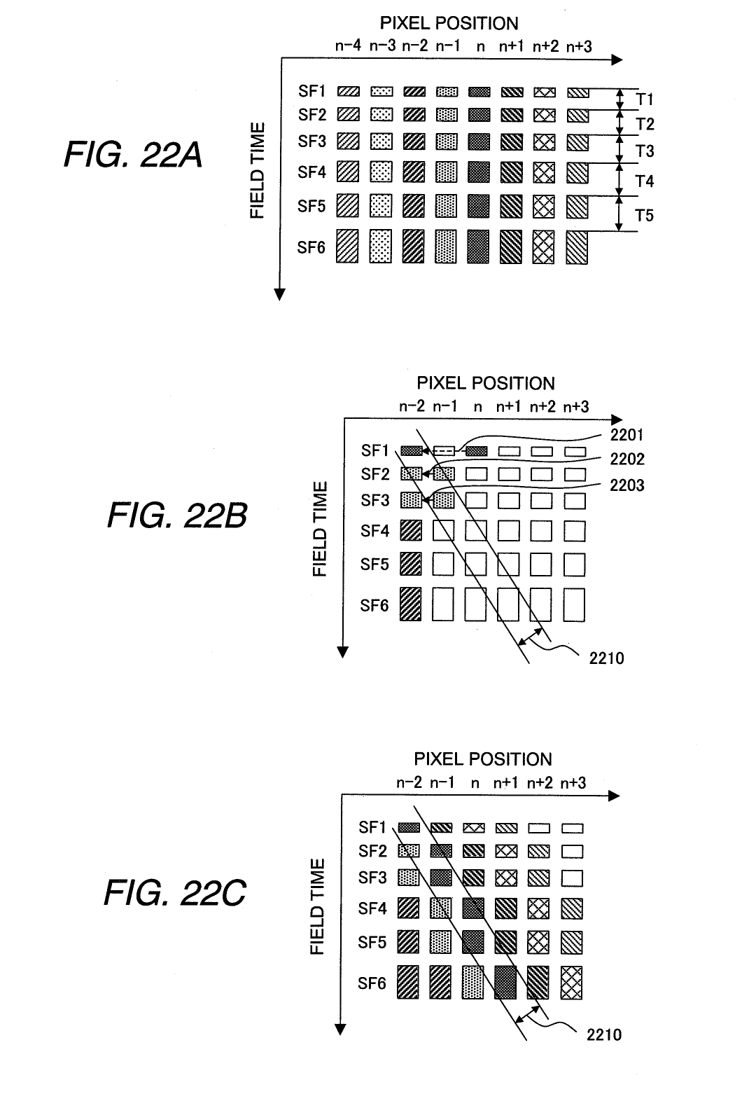

FIGS. 21A to 21C and 22A to 22C are diagrams showing examples of subfield rearrangement according to the present embodiment. In the image display method of the present embodiment, the intervals between subfield emission start times are variable, as in the second embodiment, with subfield emission periods taken into consideration. Furthermore, the present embodiment assumes that the emission start times of the subfields in each field display period (16.67 ms for 60-Hz image display) are as specified for (2) in Table 1.

The method of subfield rearrangement according to the present embodiment differs between a case where the brightness difference between pixels is smaller than or equal to a threshold value and a case where the brightness difference between pixels is larger than the threshold value. Subfield rearrangements in both cases will be described below.

With reference to FIGS. 21A to 21C, subfield rearrangement made in a case where the brightness difference between pixels is smaller than or equal to a threshold value, i.e. subfield rearrangement for a similar-color area, will be described below. FIG. 21A shows a subfield arrangement before being rearranged. In this case, it is assumed that the brightness difference between pixels ranging from (n−4) to (n+3) is smaller than or equal to a threshold value.

In the present embodiment, the process shown in FIG. 3 is carried out as follows. In step 111, a motion vector F is assigned to variable A, and a subfield emission start time is assigned to variable B. In step 112, whether variable B is equal to the number of subfields is determined. In the present case, variable B represents a subfield emission start time, so that, in step 114, a pixel position vector Xi (x, y) for acquiring a subfield is determined based on the motion vector F represented by variable A and the subfield emission start time represented by variable B. In step 115, whether the brightness difference between the pixel indicated by the pixel position vector Xi (x, y) determined in step 114 and the pixel to be rearranged is either smaller than or equal to a threshold value is determined. In the present case, the brightness difference between pixels ranging from (n−4) to (n+3) is smaller than or equal to the threshold value, so that the procedure advances to step 116 where the determined pixel position vector X1 (x, y) is outputted.

The process performed in step 114 shown in FIG. 3 will be described in detail below.

With reference to FIG. 14, the present embodiment assumes concerning the motion vector E extending from pixel a of the preceding field A through pixel b of the intermediate field B to pixel c of the current field C that pixel a from which the motion vector E extends is positioned at horizontally −6 relative to pixel c at which the motion vector E ends. With reference to FIG. 14, it is also assumed that the intermediate field B is positioned in the middle (α=0.5) of the TV field period between the preceding field A and the current field C. Then, pixel a of the preceding field A from which the motion vector F extends is positioned at horizontally −3 relative to pixel b of the intermediate field B at which the motion vector F ends. In this state, vector value Vf of the motion vector F is +3.

In the present embodiment, the pixel position of each subfield to be acquired for subfield rearrangement is determined based on the pixel to be rearranged and using equation 6 shown below. The parameters included in the equation are the same as those included in the equations used in the foregoing embodiments.

Xi=−Vf×{Si−(Tf×α)}/(Tf×α) (Equation 6)

As described above, in the present embodiment, out of the motion vectors F extending between the preceding field A and the intermediate field B, one extending from pixel a of the preceding field A to pixel b to be rearranged of the intermediate field B is selected, a pixel position vector is calculated for each subfield of each pixel to be rearranged using equation 6, and the subfield is rearranged. The process will be described below.

FIG. 21B shows the result of subfield rearrangement made for pixel (n−1) of the object field. The motion vector F ending at pixel (n−1) to be rearranged extends from a pixel positioned at horizontally −3 relative to pixel (n−1), i.e. the value of the motion vector F is +3. The pixel position vector Xi of each subfield of pixel (n−1) of the object field can be calculated using equation 6. The pixel position vector Xi calculated using equation 6 is −1 for SF6, 0 for SF5, 0 for SF4, +1 for SF3, +1 for SF2, and +2 for SF1.

Therefore, SF6 obtains subfield emission data from pixel (n−2) as shown by arrow 2106 in FIG. 21B; SF5 and SF4 remain unchanged with their emission data on pixel (n−1); SF3 obtains subfield emission data from pixel n as shown by arrow 2103; SF2 obtains subfield emission data from pixel n as shown by arrow 2102; and SF1 obtains subfield emission data from pixel (n+1) as shown by arrow 2101. In this way, the subfield emission data is rearranged for the subfields of pixel (n−1).

FIG. 21C shows the result of emission data rearrangement carried out for every one of the pixels to be rearranged. This example assumes that every motion vector F ending at a pixel to be rearranged of the intermediate field B extends from a pixel which is, the same as in the above case of pixel (n−1), positioned at horizontally −3 relative to the pixel to be rearranged and that all such motion vectors F have a same value of +3. As done for pixel (n−1), a pixel position vector Xi is calculated using equation 6 for every subfield of every pixel to be rearranged. Subsequently, every subfield of every pixel to be rearranged is rearranged using the subfield at the pixel position indicated by the corresponding pixel position vector Xi. Consequently, each set of plural subfields associated with a same pixel for a still picture are aligned along a line-of-sight path 2110. The line-of-sight path 2110 is less inclined than the line-of-sight path 1710 shown in FIGS. 17B and 17C. This is because, in the present embodiment, the subfields emit light at variable intervals such that they start emission earlier than the corresponding subfields emitting light at regular intervals.

With reference to FIGS. 22A to 22C, subfield rearrangement made in a case where the brightness difference between pixels is, depending on the pixels compared, larger than a threshold value, i.e. subfield rearrangement for a non-similar-color area will be described below.

FIG. 22A shows a subfield arrangement before being rearranged. In this case, it is assumed that, whereas the brightness difference between pixels (n−4) and (n−3) and between pixels ranging from (n−2) to (n+3) is smaller than or equal to a threshold value, the brightness difference between pixels (n−3) and (n−2) is larger than the threshold value.

FIG. 22B shows the result of subfield rearrangement made for pixel (n−2). The motion vector F ending at pixel (n−2) to be rearranged extends from a pixel positioned at horizontally −3 relative to pixel (n−2), i.e. the motion vector value is +3. The pixel position vector Xi of each subfield of pixel (n−2) is calculated, using equation 6, as in step 114 shown in FIG. 3. The values of pixel position vectors Xi thus calculated are −1 for SF6, 0 for SF5, 0 for SF4, +1 for SF3, +1 for SF2, and +2 for SF1.

Subsequently, the brightness differences between pixels are checked. For subfield SF6, for example, a pixel position vector Xi (−1, 0) is obtained in step 114. Next, in step 115, the brightness difference between pixels (n−3) and (n−2) is checked. Since the brightness difference between pixels (n−3) and (n−2) is larger than the threshold value, the procedure advances to step 117. Since the value of x determined in step 114 is −1, the procedure advances from step 117 to step 119, then to step 124. In step 124, the value of x is incremented by 1 to 0, then the procedure returns to step 115 to check the brightness difference between pixels (n−2) and (n−2). Since the brightness difference between pixels (n−2) and (n−2) is 0, i.e. smaller than or equal to the threshold value, the procedure advances to step 116. In step 116, the pixel position vector Xi of SF6 corrected from (−1, 0) to (0, 0) is outputted. Pixel position vectors Xi for the other subfields are also calculated in a similar manner. The values of pixel position vectors Xi thus calculated are 0 for SF5, 0 for SF4, +1 for SF3, +1 for SF2, and +2 for SF1.

In the present case, therefore, SF6, SF5 and SF4 remain unchanged with their emission data on pixel (n−2) as shown in FIG. 22B; SF3 obtains subfield emission data from pixel (n−1) as shown by arrow 2203; SF2 obtains subfield emission data from pixel (n−1) as shown by arrow 2202; and SF1 obtains subfield emission data from pixel n as shown by arrow 2201. In this way, the subfield emission data is rearranged for the subfields of pixel (n−2).

FIG. 22C shows the result of emission data rearrangement carried out for every pixel to be rearranged. In the present embodiment, the subfields to be rearranged are rearranged using only subfields of similar colors to them, and subfields of largely differing colors are not used. The rearranged subfields, therefore, do not show false colors even outside a similar-color area. This makes it possible to inhibit the generation of false contours.

According to the fourth embodiment described above, every subfield of every pixel can be rearranged taking a viewer's line-of-sight path into consideration. This makes it possible, while inhibiting moving image blurring and the generation of dynamic false contours, to prevent subfields to be rearranged from being left without being rearranged. When a display method in which subfield emission intervals are variable according to the image display load factor is used, too, the subfields can be rearranged into an emission pattern better matching the viewer's sight-of-line path.

The subfields to be rearranged are rearranged using only subfields of similar colors to them, and subfields of largely differing colors are not used. The rearranged subfields, therefore, do not show false colors, so that it is possible to inhibit the generation of false contours. Furthermore, the distances by which subfields are moved for subfield rearrangement can be reduced. This makes it possible to inhibit image shaking and realize more natural image display.

The above described example of subfield rearrangement is based on a case where the subfields of each field sequentially emit light earlier than in cases where the subfields of each field sequentially emit light at regular intervals. The same advantageous effects as those obtained in the above example can be obtained, by rearranging subfields using equation 6, also in cases where the subfields of each field sequentially emit light later than in cases where the subfields of each field sequentially emit light at regular intervals causing the line-of-sight path to be more inclined.

### Embodiment 5

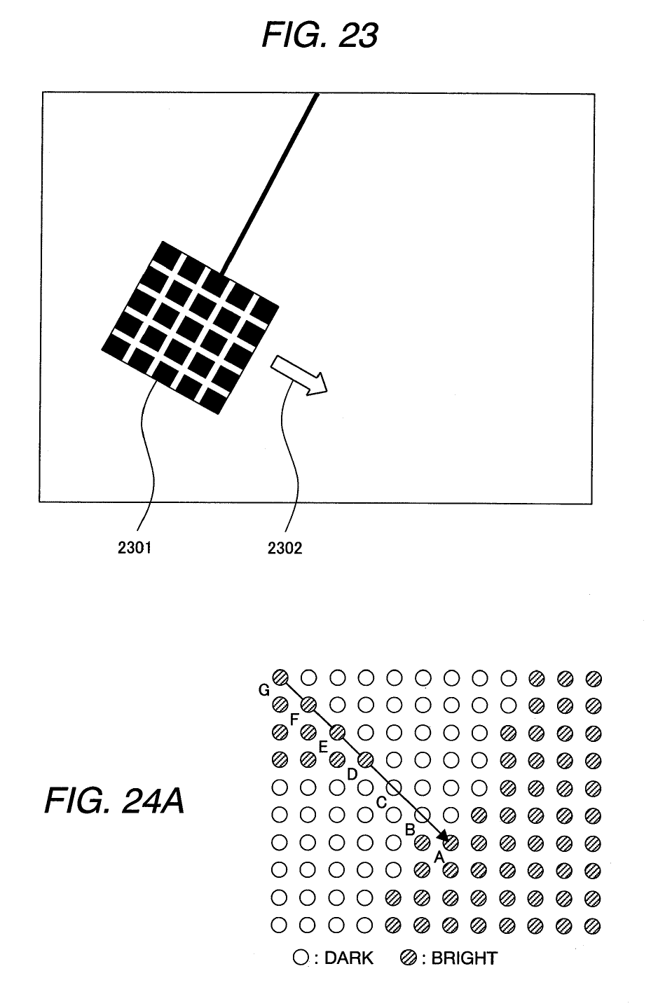

A fifth embodiment of the present invention will be described below using concrete example images. Namely, out of the images included in the standard moving image collection compiled under the supervision of the Institute of Image Information and Television Engineers, “No. 30 Crowd” is used as image A, and “No. 55 Pendulum (shutter speed: 1/1000 s)” is used as image B. The latter is shown in FIG. 23.

How these images A and B can be displayed by existing methods will be explained in the following.

When the method disclosed in Japanese Patent Laid-Open No. H08-211848 is applied to image A, the false contour of a woman wearing white clothes can be reduced, but some subfields are left without being set. As a result, the boundary between the image of the woman and the background image suffers image quality deterioration due to lowering of brightness. Similarly, when the method disclosed in Japanese Patent Laid-Open No. H08-211848 is applied to image B, some subfields are left without being set. As a result, the boundary between a pendulum 2301, shown in FIG. 23, and the background image suffers image quality deterioration due to lowering of brightness.

When the method disclosed in Japanese Patent Laid-Open No. 2002-123211 is applied to image A, the false contour of the woman wearing white clothes is reduced, but, with the woman moving her arms and hands fairly quickly, her image is blurred. In addition, in adjusting the image using detected motion vectors only, subfields of pixels of largely differing colors are acquired. This causes false colors to be generated and image quality to deteriorate. When the method disclosed in Japanese Patent Laid-Open No. 2002-123211 is applied to image B, subfields of pixels of largely differing colors are acquired depending on the amount of movement of the pendulum 2301. This causes the colors of black pixels and white pixels representing the pendulum to change and the image of the pendulum to deteriorate.

Next, how these images A and B can be displayed by the methods according to the foregoing embodiments of the present invention will be explained in the following. When image A is adjusted by the methods of the foregoing embodiments, subfields to be rearranged are rearranged using only subfields of pixels of similar colors to them based on motion vectors and brightness information and reflecting the amount of image movement. This reduces the false contour of the woman wearing white clothes without causing image deterioration. When image B is adjusted by the methods of the foregoing embodiments, subfields to be rearranged are rearranged using only subfields of pixels of similar colors to them based on motion vectors and brightness information and reflecting the amount of image movement. This does not significantly change the colors of black pixels and white pixels representing the image, so that the image of the pendulum does not deteriorate.

Thus, the methods according to the foregoing embodiments of the present invention can prevent image quality deterioration which can result from image adjustment carried out using motion vectors only or using erroneously detected motion vectors.

### Embodiment 6

A sixth embodiment of the present invention will be explained below.

In the foregoing embodiments, for each subfield of each pixel to be rearranged, a pixel position where a subfield is to be acquired is determined such that the brightness difference between the pixel to be rearranged and the pixel to be acquired is smaller than or equal to a threshold value, and each subfield of each pixel to be rearranged is rearranged using such an acquired subfield. It is, however, possible to improve image quality without checking the brightness difference between pixels for every subfield.

In the present embodiment, only for optional subfields of each pixel to be rearranged, the brightness difference between pixels is checked, and pixel positions where subfields to be used to rearrange such optional subfields are to be acquired are determined. For other subfields, the brightness difference between pixels is not checked. Such other subfields are rearranged using subfields acquired at pixel positions initially determined using an appropriate equation. For example, the brightness difference between pixels is checked only for heavily weighted subfields, and pixel positions where subfields to be used to rearrange the heavily weighted subfields are to be acquired are determined. Lightly weighted subfields are less likely to generate false colors, so that they are rearranged, for pixel rearrangement, using subfields acquired at pixel positions determined using an appropriate equation without checking the brightness difference between pixels.

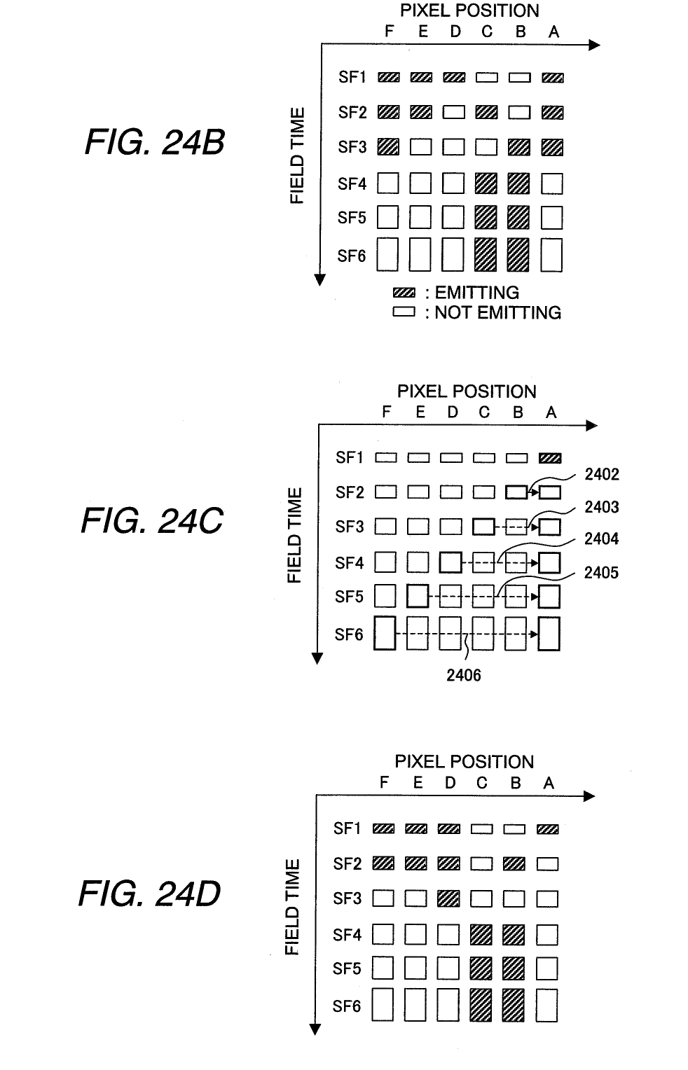

FIGS. 24A to 24D show an example display pattern according to the sixth embodiment. FIG. 24A shows pixels on a two-dimensional plane. The display pattern shown in FIG. 24A is the same as that shown in FIG. 8A. In FIG. 24A, pixels A to G are shown to have moved by six pixels in the direction of pixel G to pixel A. FIG. 24B shows a display pattern before being rearranged. In this case, the brightness difference between pixels is checked only for heavily weighted subfields SF4 to SF6 in determining pixel positions where subfields to be used to rearrange such heavily weighted subfields are to be acquired. Lightly weighted subfields SF1 to SF3 are rearranged using subfields acquired at pixel positions initially determined using an appropriate equation without checking the brightness difference between pixels. Each pixel to be rearranged is rearranged by subfield rearrangement carried out as described above.

FIG. 24C shows the result of rearrangement of pixel A. As shown, pixel A is rearranged by acquiring SF6 from pixel F (arrow 2406), SF5 from pixel E (arrow 2405), SF4 from pixel D (arrow 2404), SF3 from pixel C (arrow 2403), SF2 from pixel B (arrow 2402), and SF1 from pixel A.

FIG. 24D shows the result of rearrangement of all pixels A to F carried out in a similar manner.

Heavily weighted subfields which can significantly affect colors displayed are rearranged without using subfields largely differing in color from them, so that, as FIGS. 24B and 24D show, the subfield emission pattern after rearrangement does not largely differ from the subfield emission pattern before rearrangement. According to the present embodiment, therefore, processing to be performed to check the brightness difference between pixels can be reduced, and it is made possible to reduce the circuit size of the display apparatus without allowing false color generation and inhibit the generation of false contours.

The above embodiments of the present invention can be modified, for example, as follows.

Even though the third and fourth embodiments have been explained based on a case where the intermediate field B is positioned in the middle (α=0.5) of the TV field period between the preceding field A and the current field C, the advantageous effects of the third and fourth embodiments do not change even in cases where the intermediate field B is positioned other than in the middle of the TV field period between the preceding field A and the current field C.

Even though, the above embodiments of the present invention have been explained referring to subfield emission start times as time parameters representing emitting positions of subfields, other parameters than subfield emission start times may be used. For example, emission periods between subfield emission start times and emission end times may be used as parameters.

Even though, the above embodiments of the present invention have been explained referring to motion vectors V or Vf as one-dimensional values related with horizontal movements only, the advantageous effects of the above embodiments do not change even in cases where motion vectors V and Vf are two-dimensional values.

Even though, the above embodiments of the present invention have been explained based on the assumption that the number of subfields per field is six, the advantageous effects of the above embodiments do not change even incases where the number of subfields per field is other than six.

The brightness difference between pixels to be checked by the pixel position changing section used in the above embodiments of the present invention may be calculated from image RGB data. The advantageous effects of the above embodiments do not change even in cases where differences between individual R, G, and B data are checked instead of the brightness difference.

With reference to the flowchart shown in FIG. 3, the procedure has been explained in which first a pixel position vector (x, y) is calculated and a new pixel position vector is then determined (by incrementing or decrementing the value of x by 1) and in which next a new pixel position vector is determined (by incrementing or decrementing the value of y by 1). The procedure may be reversed such that first a new pixel position vector is determined by incrementing or decrementing the value of y of an initially calculated pixel position vector and such that next a new pixel position vector is determined by incrementing or decrementing the value of x. A new pixel position vector may also be determined by incrementing or decrementing the values of x and y by 1 each at the same time. As long as a pixel position vector calculation method in which a pixel position vector is adjusted, until being finally determined for application, so as to indicate a pixel closer to the pixel to be rearranged is used, the advantageous effects of the above embodiments do not change.

Combining any parts, for example, drawings or methods, of the above embodiments of the present invention can make up another embodiment of the present invention.

According to any one of the above embodiments of the present invention, image quality deterioration can be better prevented. The advantageous effects of individual ones of the above embodiments include the following.

The first embodiment can inhibit the generation of false colors caused by inaccurately detected motion vectors or motion vectors extending in various directions and makes it possible to reduce the amount of arithmetic processing to be performed while preventing image quality deterioration. The second embodiment can inhibit the generation of false colors caused by inaccurately detected motion vectors or motion vectors extending in various directions and makes it possible to better inhibit moving image blurring and the generation of dynamic false contours. The third embodiment can inhibit the generation of false colors caused by inaccurately detected motion vectors or motion vectors extending in various directions and makes it possible to inhibit image shaking, realize more natural image display, and reduce the amount of arithmetic processing to be performed. The fourth embodiment can inhibit the generation of false colors caused by inaccurately detected motion vectors or motion vectors extending in various directions and makes it possible to better inhibit moving image blurring and the generation of dynamic false contours while also inhibiting image shaking.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. An image display apparatus wherein one field period of an input image is divided into a plurality of subfield periods, and emission data for each of the plurality of subfield periods is rearranged according to a motion vector extending between pixels mutually corresponding between fields, the image display apparatus comprising:
a subfield conversion section which converts an input image into emission data for a plurality of subfields;
a motion vector detection section which detects a motion vector extending between pixels mutually corresponding between two mutually neighboring fields included in a plurality of fields of the input image or generated from the plurality of fields;
a brightness information calculation section which calculates, from the input image, brightness information for each pixel;
a pixel position changing section which calculates, by performing arithmetic processing using a motion vector detected by the motion vector detection section and brightness information calculated by the brightness information calculation section, a pixel position vector indicating from where to acquire data for use in rearranging emission data;
a subfield rearrangement section which rearranges emission data, outputted from the subfield conversion section, for a subfield of a pixel in a field to be rearranged using emission data for a corresponding subfield of another pixel included in the field to be rearranged and indicated by a pixel position vector calculated by the pixel position changing section; and
a display section which displays an image using subfield emission data outputted from the subfield rearrangement section;
wherein the pixel position changing section:
selects, out of the motion vectors detected by the motion vector detection section, a motion vector ending at a pixel to be rearranged in the field to be rearranged;
calculates the pixel position vector by multiplying the selected motion vector by a predetermined function;
checks, based on the brightness information calculated by the brightness information calculation section, a brightness difference between the pixel indicated by the calculated pixel position vector and the pixel to be rearranged; and,
when the brightness difference is larger than a threshold value, outputs the calculated pixel position vector after correcting it to change the pixel indicated thereby to one closer to the pixel to be rearranged until the brightness difference between the pixel thus changed to and the pixel to be rearranged is equal to or smaller than the threshold value.

2. The image display apparatus according to claim 1,
wherein the pixel position changing section calculates a pixel position vector for every subfield of the pixel to be rearranged; and
wherein the subfield rearrangement section rearranges emission data for every subfield of the pixel to be rearranged using emission data for a corresponding subfield of a pixel indicated by the calculated pixel position vector.

3. The image display apparatus according to claim 2,
wherein the pixel position changing section calculates, for every subfield of the pixel to be rearranged, a pixel position vector by multiplying the selected motion vector by a predetermined function; and
wherein the pixel position vector, only for optional subfields of the pixel to be rearranged, checks the brightness difference between the pixel indicated by the pixel position vector calculated based on the brightness information and the pixel to be rearranged, and, when the brightness difference is larger than a threshold value, corrects the calculated pixel position vector.

4. The image display apparatus according to claim 1,
wherein the motion vector detection section detects a motion vector ending at a pixel of a first field of the input image and starting from a corresponding pixel of a second field of the input image, the second field preceding the first field; and
wherein the pixel position changing section, to rearrange an ith subfield out of as many as N subfields of a pixel of the first field, selects, out of the motion vectors detected by the motion vector detection section, a motion vector V ending at the pixel of the first field, and determines a pixel position vector by multiplying the selected motion vector V by −(i−1)/N as the predetermined function.

5. The image display apparatus according to claim 1,
wherein the motion vector detection section detects a motion vector ending at a pixel of a first field of the input image and starting from a corresponding pixel of a second field of the input image, the second field preceding the first field; and
wherein the pixel position changing section, to rearrange, out of the subfields of a pixel of the first field, a subfield which starts emission when a time period Si elapses after a beginning of a TV field period Tf between the second and first fields, selects, out of the motion vectors detected by the motion vector detection section, a motion vector V ending at the pixel of the first field, and determines a pixel position vector by multiplying the selected motion vector V by −Si/Tf as the predetermined function.

6. The image display apparatus according to claim 1,
wherein the motion vector detection section detects a motion vector ending at a pixel of a third field generated between a first field and a second field of the input image, the second field preceding the first field, and starting from a corresponding pixel of the second field; and
wherein the pixel position changing section, to rearrange, out of as many as N subfields of a pixel of one of the third, first, and second fields, an ith subfield, selects, out of the motion vectors detected by the motion vector detection section, a motion vector Vf ending at a corresponding pixel of the third field, and determines the pixel position vector by multiplying the selected motion vector Vf by −{(i−1)−(N×α)}/(N×α) as the predetermined function, a representing a ratio of a period Tm between the second and third fields to a period Tf between the second and first fields (α=Tm/Tf).

7. The image display apparatus according to claim 1,
wherein the motion vector detection section detects a motion vector ending at a pixel of a third field generated between a first field and a second field of the input image, the second field preceding the first field, and starting from a corresponding pixel of the second field; and
wherein the pixel position changing section, to rearrange, out of the subfields of a pixel of one of the third, first, and second, fields, a subfield which starts emission when a time period Si elapses after a beginning of a TV field period Tf between the second and first fields, selects, out of the motion vectors detected by the motion vector detection section, a motion vector Vf ending at a corresponding pixel of the third field, and determines the pixel position vector by multiplying the selected motion vector Vf by −{Si−(Tf×α)}/(Tf×α) as the predetermined function, a representing a ratio of a period Tm between the second and third fields to the period Tf between the second and first fields (α=Tm/Tf).

8. The image display apparatus according to claim 4, wherein the subfields sequentially start emission at regular intervals.

9. The image display apparatus according to claim 5, wherein intervals at which the subfields sequentially start emission are variable according to a brightness level of the input image.

10. An image display method in which one field period of an input image is divided into a plurality of subfield periods, and emission data for each of the plurality of subfield periods is rearranged according to a motion vector extending between pixels mutually corresponding between fields, the image display method comprising the steps of:
converting an input image into emission data for a plurality of subfields;
detecting a motion vector extending between pixels mutually corresponding between two mutually neighboring fields included in a plurality of fields of the input image or generated from the plurality of fields;
calculating, from the input image, brightness information for each pixel;
calculating, by performing arithmetic processing using the detected motion vector and the calculated brightness information, a pixel position vector indicating from where to acquire data for use in rearranging emission data;
rearranging emission data for a subfield of a pixel in a field to be rearranged using emission data for a corresponding subfield of another pixel included in the field to be rearranged and indicated by the calculated pixel position vector; and
displaying an image using emission data for the subfield to be rearranged;
wherein, in the step of calculating a pixel position vector:
a motion vector ending at a pixel to be rearranged in the field to be rearranged is selected;
a pixel position vector is calculated by multiplying the selected motion vector by a predetermined function;
based on the calculated brightness information, a brightness difference between the pixel indicated by the calculated pixel position vector and the pixel to be rearranged is checked; and,
when the brightness difference is larger than a threshold value, the calculated pixel position vector is corrected to change the pixel indicated thereby to one closer to the pixel to be rearranged until the brightness difference between the pixel thus changed to and the pixel to be rearranged is equal to or smaller than the threshold value.

11. The image display method according to claim 10,
wherein, in the step of detecting a motion vector, a motion vector ending at a pixel of a first field of the input image and starting from a corresponding pixel of a second field of the input image is detected, the second field preceding the first field; and
wherein, in the step of calculating a pixel position vector, to rearrange an ith subfield out of as many as N subfields of a pixel of the first field, a motion vector V ending at the pixel of the first field is selected out of the detected motion vectors, and the pixel position vector is determined by multiplying the selected motion vector V by −(i−1)/N as the predetermined function.

12. The image display method according to claim 10,
wherein, in the step of detecting a motion vector, a motion vector ending at a pixel of a first field of the input image and starting from a corresponding pixel of a second field of the input image is detected, the second field preceding the first field; and
wherein, in the step of calculating a pixel position vector, to rearrange, out of the subfields of a pixel of the first field, a subfield which starts emission when a time period Si elapses after a beginning of a TV field period Tf between the second and first fields, a motion vector V ending at the pixel of the first field is selected out of the detected motion vectors, and the pixel position vector is determined by multiplying the selected motion vector V by −Si/Tf as the predetermined function.

13. The image display method according to claim 10,
wherein, in the step of detecting a motion vector, a motion vector ending at a pixel of a third field generated between a first field and a second field of the input image and starting from a corresponding pixel of the second field is detected, the second field preceding the first field; and
wherein, in the step of calculating a pixel position vector, to rearrange, out of as many as N subfields of a pixel of one of the third, first, and second fields, an ith subfield, a motion vector Vf ending at a corresponding pixel of the third field is selected out of the detected motion vectors, and the pixel position vector is determined by multiplying the selected motion vector Vf by −{(i−1)−(N×α)}/(N×α) as the predetermined function, α representing a ratio of a period Tm between the second and third fields to a period Tf between the second and first fields (α=Tm/Tf).

14. The image display method according to claim 10,
wherein, in the step of detecting a motion vector, a motion vector ending at a pixel of a third field generated between a first field and a second field of the input image and starting from a corresponding pixel of the second field is detected, the second field preceding the first field; and
wherein, in the step of calculating a pixel position vector, to rearrange, out of the subfields of a pixel of one of the third, first, and second fields, a subfield which starts emission when a time period Si elapses after a beginning of a TV field period Tf between the second and first fields, a motion vector Vf ending at a corresponding pixel of the third field is selected out of the detected motion vectors, and the pixel position vector is determined by multiplying the selected motion vector Vf by −{Si−(Tf×α)}/(Tf×α) as the predetermined function, a representing a ratio of a period Tm between the second and third fields to the period Tf between the second and first fields (α=Tm/Tf).
